(19) United States
(12) Patent Application Publication
(10) Pub. No.: US 2026/0267333 A1
(43) Pub. Date: Sep. 10, 2026

(54) INFORMATION DISPLAY METHOD FOR FLIGHT EQUIPMENT AND ELECTRONIC DEVICE

(71) Applicant: Meituan Technology Co., Ltd., Shenzhen, Guangdong (CN)

(72) Inventors: Yiping WEN, Shenzhen (CN); Kun ZHANG, Shenzhen (CN); Fenghua WANG, Shenzhen (CN)

(21) Appl. No.: 19/163,425

(22) PCT Filed: Nov. 28, 2024
(86) PCT No.: PCT/CN2024/135383

§ 371 Date: Sep. 9, 2025

(30) Foreign Application Priority Data
Jan. 4, 2024 (CN) 202410027035.8

(51) Int. Cl. G05D 1/227; G01C 21/20; G05D 1/86; G05D 109/25; G08G 5/23

(52) U.S. Cl. CPC G05D 1/227; G01C 21/20; G05D 1/86; G08G 5/23; G05D 2109/254

(57) ABSTRACT

An information display method for flight equipment and an electronic device are disclosed. The method includes: sequentially arranging phase identifiers of a plurality of flight phases of a flight device within a preset geographic range in a first information display region, wherein each flight phase is corresponding to one or more flight routes; and displaying, in response to a monitoring instruction, a dynamic identifier of the flight device at an associated location of a flight phase and flight route in which the flight device is located.

This application is a U.S. National Stage of International Application No. PCT/CN2024/135383 filed on Nov. 28, 2024, which claims priority to Chinese patent application No. 202410027035.8, filed on Jan. 4, 2024, and titled “FLIGHT DEVICE INFORMATION DISPLAY METHOD AND ELECTRONIC DEVICE”, the contents of both of which are incorporated herein by reference in their entirety.

### FIELD OF TECHNOLOGY

This disclosure relates to the field of the flight control technology, and in particular to a flight device information display method and an electronic device.

### BACKGROUND

To manage a flight device, a motion trajectory of the flight device is usually displayed on a two-dimensional map. A target object can manage the flight device through the motion trajectory of the flight device displayed on the map.

### SUMMARY

This disclosure is intended to provide a flight device information display method and an electronic device, to resolve a problem of unclear and inefficient control and management of a flight device.

An embodiment of this disclosure provides a flight device information display method, including: sequentially arranging phase identifiers of a plurality of flight phases of a flight device within a preset geographic range in a first information display region, where each flight phase is corresponding to one or more flight routes; and displaying, in response to a monitoring instruction, a dynamic identifier of the flight device at an associated location of a flight phase and a flight route in which the flight device is located.

An embodiment of this disclosure provides a flight device information display apparatus, including: a phase identifier display module and a dynamic identifier display module. The phase identifier display module can be configured to sequentially arrange phase identifiers of a plurality of flight phases of a flight device within a preset geographic range in a first information display region, and each flight phase is corresponding to one or more flight routes. The dynamic identifier display module can be configured to display, in response to a monitoring instruction, a dynamic identifier of the flight device at an associated location of a flight phase and a flight route in which the flight device is located.

An embodiment of this disclosure provides an electronic device, including: a memory and a processor, where the memory is configured to store computer program instructions; the processor invokes the computer program instructions stored in the memory to implement the flight device information display method described in any of the above.

An embodiment of this disclosure provides a non-transitory computer-readable storage medium, on which computer program instructions are stored to implement the flight device information display method described in any of the above.

An embodiment of this disclosure provides a computer program product or computer program, which includes computer program instructions stored in a computer-readable storage medium. The computer program instructions are read from the computer-readable storage medium, and the processor executes the computer program instructions to implement the above flight device information display method.

### BRIEF DESCRIPTION OF THE DRAWINGS

It is apparent that the drawings described below are merely some embodiments of this disclosure. For those skilled in the art, other drawings can be obtained based on these drawings without creative effort.

FIG. 1 is a schematic diagram of a scenario in which a flight device information display method or a flight device information display apparatus can be used in an embodiment of this disclosure.

FIG. 2 is a flowchart illustrating a flight device information display method according to an exemplary embodiment.

FIG. 3 is a flowchart illustrating a flight device information display method according to an exemplary embodiment.

FIG. 4 is a flowchart illustrating a flight device information display method according to an exemplary embodiment.

FIG. 5 is a schematic diagram illustrating display of flight phase indication information according to an exemplary embodiment.

FIG. 6 is a schematic diagram illustrating display of flight phase indication information according to an exemplary embodiment.

FIG. 7 is a schematic diagram illustrating display of flight phase indication information according to an exemplary embodiment.

FIG. 8 is a schematic diagram illustrating display of flight phase indication information according to an exemplary embodiment.

FIG. 9 is a schematic diagram illustrating display of flight phase indication information according to an exemplary embodiment.

FIG. 10 is a schematic diagram illustrating display of flight phase indication information according to an exemplary embodiment.

FIG. 11 is a schematic diagram illustrating display of flight phase indication information according to an exemplary embodiment.

FIG. 12 is a schematic diagram illustrating display of flight phase indication information according to an exemplary embodiment.

FIG. 13 is a schematic diagram illustrating display of flight phase indication information according to an exemplary embodiment.

FIG. 14 is a schematic diagram illustrating display of flight phase indication information according to an exemplary embodiment.

FIG. 15 is a flowchart illustrating a control reference information display method for a flight device according to an exemplary embodiment.

FIG. 16 is a flowchart illustrating a flight device information display method according to an exemplary embodiment.

FIG. 17 is a schematic diagram illustrating a layout of a second information display region according to an exemplary embodiment.

FIG. 18 is a schematic diagram illustrating display of a second information display region in a task waiting phase according to an exemplary embodiment.

FIG. 19 is a flowchart illustrating a flight device information display method according to an exemplary embodiment.

FIG. 20 is a schematic diagram illustrating display of control reference information according to an exemplary embodiment.

FIG. 21 is a flowchart illustrating a control element activation method according to an exemplary embodiment.

FIG. 22 is a flowchart illustrating a flight device information display method according to an exemplary embodiment.

FIG. 23 is a schematic diagram illustrating display of a takeover control element according to an exemplary embodiment.

FIG. 24 is a schematic diagram illustrating display of a takeover determining control element according to an exemplary embodiment.

FIG. 25 is a schematic diagram illustrating display of a device identifier after a flight device is taken over according to an exemplary embodiment.

FIG. 26 is a schematic diagram illustrating display of a control element in an active state according to an exemplary embodiment.

FIG. 27 is a schematic diagram illustrating display of a takeover ending control element according to an exemplary embodiment.

FIG. 28 is a flowchart illustrating an (Unmanned Aerial Vehicle) UAV device information display method according to an exemplary embodiment.

FIG. 29 is a block diagram illustrating a flight device information display apparatus according to an exemplary embodiment.

FIG. 30 is a schematic structural diagram of an electronic device suitable for implementing the embodiments of this disclosure.

### DESCRIPTION OF THE EMBODIMENTS

Exemplary embodiments are described more comprehensively with reference to accompanying drawings. However, the exemplary embodiments can be implemented in various forms and should not be construed to be limited to the embodiments described herein.

Flowcharts shown in the accompanying drawings are merely illustrative, and neither necessarily include all content and steps, nor are executed in a described order. For example, some steps can be split, while others can be merged or partially merged, and an actual execution order may change depending on a specific situation.

In the description of this disclosure, unless otherwise stated, “/” indicates “or.” For example, A/B can mean A or B. The term “and/or” in this specification describes only an association relationship between associated objects and indicates that three relationships may exist. For example, A and/or B may represent the following three cases: Only A exists, both A and B exist, and only B exists.

Implementations of this disclosure are described in detail below with reference to the accompanying drawings.

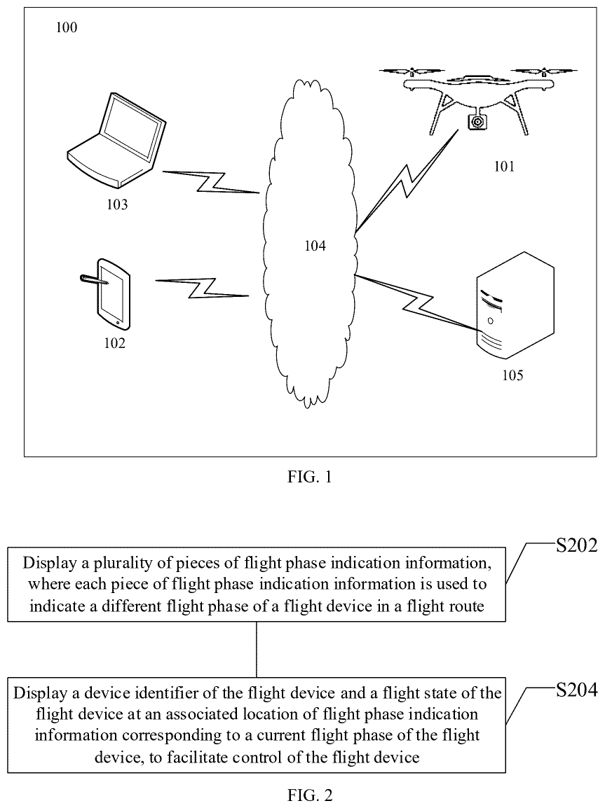

FIG. 1 is a schematic diagram of a scenario in which a flight device information display method or a flight device information display apparatus can be used in an embodiment of this disclosure. As shown in FIG. 1, a system architecture 120 may include a flight device 101, terminal devices 102 and 103, a network 104, and a server 105. The network 104 is used to provide a communication link medium among the flight device 101, the terminal devices 102 and 103, and the server 105. The network 104 may include various connection types, such as a wireless communication link, and the like.

A user can interact with the server 105 using the flight device 101 or the terminal devices 102 and 103 through the network 104 to send or receive messages, and the like. The flight device 101 may be an airplane, a UAV, or another device that can fly. The flight device may be a single device or a group of flight devices, which is not limited in this application. The terminal devices 102 and 103 may be various electronic devices with display screens that support web browsing, including but not limited to smartphones, tablets, laptops, desktop computers, wearable devices, virtual reality devices, smart home devices, and the like. The server 105 may be a server providing various services, such as a backend management server that provides support for information sent by the flight device 101 and an apparatus that performs an operation using the terminal devices 102 and 103 by the user. The backend management server can analyze and process received requests and the like, and feed back a processing result to the terminal devices.

In some embodiments, the server 105 can collect flight information of the flight device 101 through the network 104, such as flight phase information, flight trajectory information, flight state information, flight environment information, and the like. The server 105 can analyze and process collected data from the flight device 101, and send an analysis and processing result to the terminal device 102 or 103 through the network 104. The terminal device 102 or 103 can, for example, sequentially arrange phase identifiers of the flight device in a plurality of flight phases within a preset geographic range in a first information display region. Each flight phase is corresponding to one or more flight routes. The terminal device 102 or 103 can display, for example, in response to a monitoring instruction, a dynamic identifier of the flight device at an associated location of a flight phase and flight route in which the flight device is located.

FIG. 2 is a flowchart illustrating a flight device information display method according to an exemplary embodiment. The method provided in this embodiment of this disclosure can be performed by an electronic device with a display capability, which is not limited thereto in this disclosure. Refer to FIG. 2. The flight device information display method provided in the embodiment of this disclosure may include the following steps.

Step S202: Display a plurality of pieces of flight phase indication information, where each piece of flight phase indication information is used to indicate a different flight phase of the flight device in a flight route.

In some embodiments, the flight device may be an airplane, a UAV, or another device that can fly.

The flight phases of the above flight device can be divided based on flight tasks of the flight device. For example, during the execution of a delivery task, the flight phases of the flight device may include a ground loading phase, an aerial flight phase, a ground delivery phase, and the like. The flight phases of the above flight device can also be divided based on a flight process of the flight device. For example, the flight device in a flight route may include phases such as pushback and taxiing, takeoff and departure, cruising, descent, landing, and the like. Alternatively, the flight phases of the flight device in a flight route may include a takeoff phase, a level flight phase, and a descent phase. Alternatively, the flight phases of the flight device in a flight route may include phases such as an origin takeoff phase, a first level flight phase, a stopover descent phase, a stopover takeoff phase, a second level flight phase, a destination descent phase, and the like. This disclosure does not limit specific flight phases included for the flight device, and those skilled in the art can set the flight phases in this disclosure based on actual flight phases corresponding to the flight device.

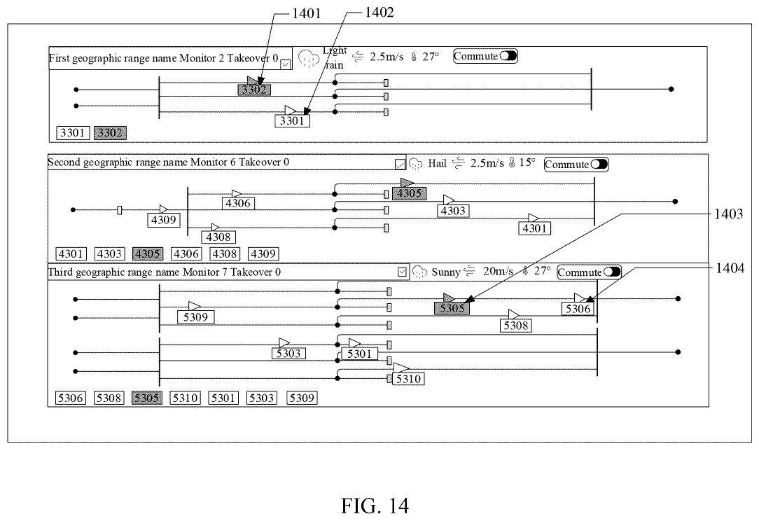

In some embodiments, the flight phase indication information can indicate a flight phase, in which the flight device is located, when a flight route is not distinguished. For example, flight devices in a flight phase in various routes are displayed together in a list format, with a specific display effect shown in FIG. 5. In some embodiments, the flight phase indication information can distinguish a flight route in which the flight device is located when the flight phase in which the flight device is located is displayed. For example, flight devices in different flight routes are displayed at locations of flight phase indication information corresponding to different flight routes, with a specific display effect shown in FIG. 14, which is not limited in this disclosure.

In some embodiments, the above flight phase indication information can be represented in various forms, such as using boxes with specific meanings, using straight lines with specific meanings, using regions with specific meanings, or using superscripts or subscripts with specific meanings. This disclosure does not limit representation forms of the flight phase indication information, and those skilled in the art can set the representation forms of the flight phase indication information based on needs.

For example, the flight phase indication information may be a box corresponding to a takeoff phase, a square box corresponding to the level flight phase, or a box corresponding to the descent phase in FIG. 5. Specific meanings of the box can be indicated through text (such as “a takeoff phase,” a “descent phase”, and the like in FIG. 5), through colors, or through fill colors of the box, which is not limited in this disclosure.

For example, the flight phase indication information may be represented by lines with specific meanings. Similarly, specific meanings of the lines can be indicated in various ways (such as text, color, line style, and the like), which is not limited in this disclosure.

In some embodiments, a trajectory of a flight device or a line, connecting an origin and destination, corresponding to the flight route in which the flight device is located, can be divided based on a flight phase of the flight device in the flight route, to obtain a plurality of sub-regions. One sub-region can be used to indicate one flight phase.

For a specific manner for displaying the flight phase indication information, reference may be made to embodiments corresponding to FIG. 5 to FIG. 14, which are not described again in this embodiment.

Step S204: Display a device identifier of the flight device and a flight state of the flight device at an associated location of flight phase indication information corresponding to a current flight phase of the flight device, to facilitate control of the flight device.

In some embodiments, the flight device may mean a device currently in flight, which could be one, two, or a plurality of devices. For example, in a UAV delivery scenario, the flight device may mean a UAV that has received a delivery task or is already in flight.

In some embodiments, a current flight phase of the flight device can be obtained in real time (for example, the flight phase of the flight device is determined as the takeoff phase), then flight phase indication information corresponding to the current flight phase is determined (for example, the flight phase indication information corresponding to the takeoff phase is determined as A), and finally, the device identifier of the flight device is displayed at the associated location of the flight phase indication information corresponding to the current flight phase (for example, the flight device is displayed at the associated location of A).

In some embodiments, the device identifier of the flight device may be a device code (such as codes 3301, 3302, and 3303 in FIG. 5), a device model (such as an airplane model, a UAV model, a model corresponding to another aircraft, or a triangular model in FIG. 14), or a combination of the device code and the device model (such as a combination of the code 3302 and the corresponding triangular model in FIG. 14). This disclosure does not limit a style of the device identifier of the flight device.

In some embodiments, a state of the flight device can be displayed through a voice, a text, a color, or the like, apart from the device identifier. For example, if the flight state of the flight device is abnormal, the abnormality can be indicated through a warning color, a warning text, or a warning voice, to alert that the flight device has an abnormality.

In some embodiments, the state of the flight device can be displayed through the device identifier of the flight device. In some embodiments, displaying the device identifier of the flight device based on the current flight state of the flight device may include: if the flight device is flying normally, displaying the device identifier of the flight device in a first state; or if the flight device is flying abnormally, displaying the device identifier of the flight device in a second state. The first state can represent a normal state, and the second state can represent an abnormal state. This application does not impose restrictions on a method for displaying the state of the flight device.

In some embodiments, the abnormal state of the device identifier can be displayed through a color, a pattern style, a background, or the like. For example, the device identifier can be displayed in red or dark color to indicate that the flight device represented by the device identifier is experiencing a flight abnormality. Alternatively, the device identifier can be displayed in yellow or light color to indicate that the flight device represented by the device identifier is in an alarm state. Alternatively, the device identifier can be displayed in white or transparent color to indicate that the flight device represented by the device identifier is flying normally.

The flight abnormality of the flight device may mean a trajectory abnormality, a device state abnormality, a flight environment abnormality (such as extreme weather conditions), or the like, which is not limited in this disclosure.

In some embodiments, if the flight device is experiencing a flight abnormality, the flight device is considered to be taken over and controlled.

In the above embodiments, the current flight state of the flight device can be displayed, and the current flight phase of the flight device can be indicated through the flight phase indication information, effectively and concisely highlighting important reference data for controlling the flight device, enabling a target object to promptly know a current flight phase and current flight state of each flight device, to facilitate management and control of the flight device.

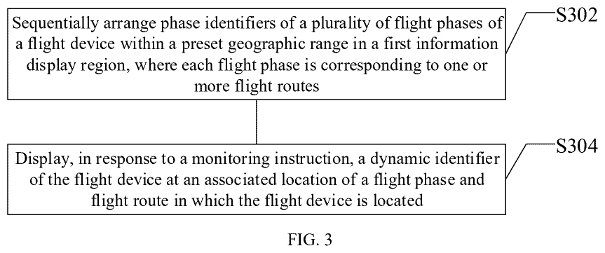

FIG. 3 is a flowchart illustrating a flight device information display method according to an exemplary embodiment. Refer to FIG. 3. The flowchart of the above flight device information display method may include the following steps.

Step S302: Sequentially arrange phase identifiers of a plurality of flight phases of a flight device within a preset geographic range in a first information display region, where each flight phase is corresponding to one or more flight routes.

In some embodiments, a terminal device may display the first information display region and a second information display region. The first information display region and the second information display region can be displayed in different locations or in the same location within the same display window, or be displayed in different display windows. The different windows can be displayed on different screens or on the same screen, which is not limited in this disclosure.

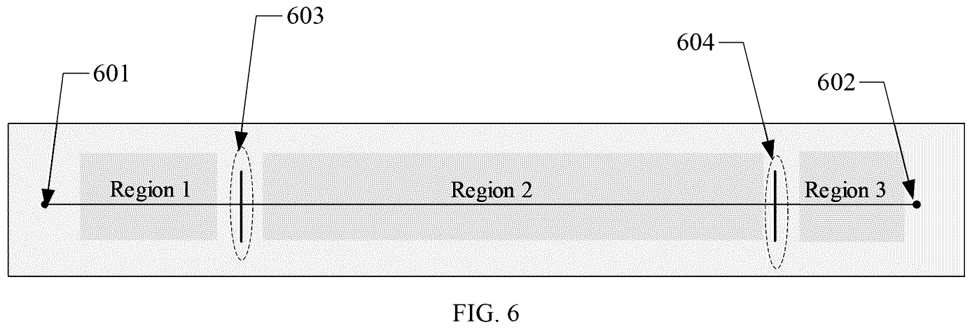

The above phase identifiers may be one type of the flight phase indication information and can be displayed using any identifier. As shown in FIG. 6, identifier 603 and identifier 604 can both be phase identifiers in this application. A region before the identifier 603 can represent a takeoff phase of the flight device, a region after the identifier 603 and before the identifier 604 can represent a level flight phase of the flight device, and a region after the identifier 604 can represent a descent phase of the flight device.

In some embodiments, the phase identifiers of the plurality of flight phases of the flight device within a preset geographic range can be sequentially arranged according to an order of flight phases experienced by the flight device during a flight process. It is apparent that the flight device needs to first experience the takeoff phase, then the level flight phase, and finally the descent phase. Therefore, as shown in FIG. 6, the identifier 603 needs to be arranged before the identifier 604.

The preset geographic range may mean a predefined province, city, county, street, commercial district, a residential region, or the like, which is not limited in this application.

In some embodiments, the first information display region may display phase identifiers corresponding to one, two, or a plurality of flight phases within the preset geographic range.

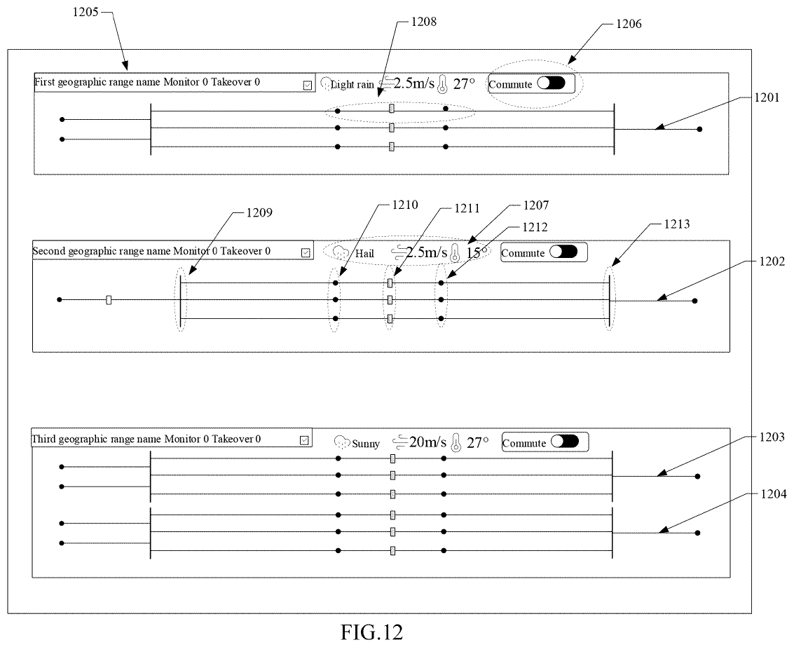

In some embodiments, there may be a plurality of preset geographic ranges in the first information display region. The phase identifiers corresponding to the plurality of preset geographic ranges are arranged horizontally or vertically in the first information display region. As shown in FIG. 12, a phase identifier corresponding to a first geographic range, a phase identifier corresponding to a second geographic range, and a phase identifier corresponding to a third geographic range are displayed vertically.

In some embodiments, phase identifiers of a plurality of flight phases within one geographic range can be arranged horizontally or vertically in the first information display region (for example, in FIG. 12, phase identifiers 1209, 1210, 1211, 1212, and 1203 are arranged horizontally).

In some embodiments, a plurality of flight routes within the same flight phase can be arranged vertically. As shown in FIG. 12, there are three flight routes at locations indicated by the phase identifiers 1209, 1210, 1211, 1212, or 1203, where three flight routes corresponding to each flight phase are arranged vertically.

In some embodiments, one phase identifier may be corresponding to one flight route (for example, as shown in FIG. 6, a phase identifier 603 is corresponding to one flight route behind itself), two flight routes, or three flight routes (for example, a phase identifier 1209 in FIG. 12 is corresponding to one flight route in front of itself and three flight routes behind itself), or the like.

Step S304: Display, in response to a monitoring instruction, a dynamic identifier of the flight device at an associated location of a flight phase and a flight route in which the flight device is located.

The above dynamic identifier may mean an identifier whose location may change over time.

The above monitoring instruction may mean an instruction for monitoring one or more flight devices. For example, when a UAV receives a delivery task in a UAV meal delivery scenario, an execution entity corresponding to this application receives a monitoring instruction. However, this application does not impose restrictions on a place at which the monitoring instruction specifically originates or content thereof.

In the technical solutions provided in the above embodiment, the flight route and flight phase of the flight device can be determined based on the location of the dynamic identifier of the flight device, effectively and concisely highlighting important reference data for controlling the flight device, enabling the target to promptly know a current flight phase and flight route of each flight device, to facilitate management and control of the flight device.

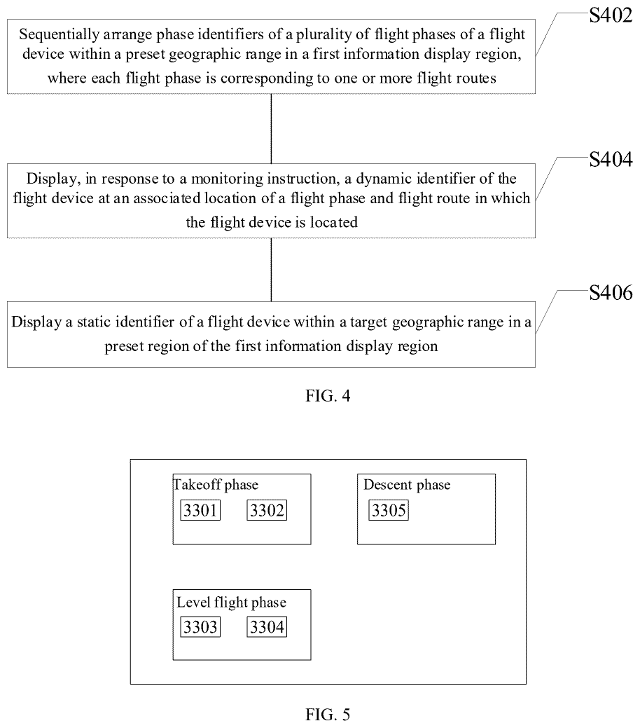

FIG. 4 is a flowchart illustrating a flight device information display method according to an exemplary embodiment. Refer to FIG. 4. The flowchart of the above flight device information display method may include the following steps.

Step S402: Sequentially arrange phase identifiers of a plurality of flight phases of a flight device within a preset geographic range in a first information display region, where each flight phase is corresponding to one or more flight routes.

Step S404: Display, in response to a monitoring instruction, a dynamic identifier of the flight device at an associated location of a flight phase and a flight route in which the flight device is located.

Step S406: Display a static identifier of a flight device within a target geographic range in a preset region of the first information display region.

In some embodiments, the above preset geographic range may include the target geographic range. In some embodiments, after in response to the monitoring instruction, the static identifier of the flight device within the target geographic range may alternatively be displayed in the preset region of the first information display region. As shown in FIG. 14, a device identifier (such as identifier 3301 or identifier 3302) of the flight device may be displayed at a lower-left corner of a first geographic range.

In some embodiments, the dynamic identifier and/or static identifier may also be used to characterize monitoring states of the flight device, which includes a normal state, a selected state, and one or more abnormal states. The above normal state, selected state, and one or more abnormal states (such as device abnormality, device warning, and the like) may be displayed through different colors, backgrounds, and the like, which is not limited in this application.

In some embodiments, the selected state may be used to characterize that the dynamic identifier and/or static identifier has been subjected to a selection operation, while the abnormal state is used to characterize that the flight device is experiencing an abnormality.

Next, different pieces of flight phase indication information are explained and described in combination with some embodiments of this disclosure.

In some embodiments, the flight phase indication information may be used to indicate a flight phase of the flight device when flying from an origin to a destination. Thus, displaying flight phase indication information may include: displaying an origin identifier corresponding to the origin, a destination identifier corresponding to the destination, and a connecting pattern between the origin identifier and the destination identifier. The connecting pattern is divided into a plurality of connecting sub-patterns based on a flight phase corresponding to the flight device when flying between the origin and the destination. The plurality of connecting sub-patterns can serve as a plurality pieces of flight phase indication information in this application, and the plurality of connecting sub-patterns are used to indicate a flight phase corresponding to the device flying between the origin and the destination.

The origin and destination may be determined based on a specific application scenario. For example, in an aircraft navigation scenario, the above origin may be a departure location of an aircraft, and the above destination may be a destination of the aircraft. Alternatively, in a UAV cargo delivery scenario, the above origin may be a cargo loading location for the UAV, and the above destination may be a cargo unloading location for the UAV. This disclosure does not impose restrictions on the above origin and destination, and those skilled in the art can determine the origin and destination based on actual requirements.

In some embodiments, the origin identifier (or destination identifier) is used to represent the origin (or destination), and may or may not contain geographic location information, which is not limited in this disclosure. For example, the origin identifier and the destination identifier may be displayed on a map, so that the origin identifier and destination identifier contain the geographic location information. Alternatively, the origin identifier and destination identifier may not be displayed on the map, such as being displayed in a blank region, so that the origin identifier and the destination identifier do not contain the geographic location information, which is not limited in this disclosure.

It should be noted that this application does not impose restrictions on specific forms of various identifiers (such as the origin identifier, the destination identifier, the device identifier, or the like).

As shown in FIG. 6, the origin identifier 601 corresponding to the origin, the destination identifier 602 corresponding to the destination, and a connecting pattern between the origin identifier 601 and the destination identifier 602 may be displayed (on a non-map location, such as a blank location). The above connecting pattern may be continuous lines such as straight lines shown in FIG. 6 or curves (not illustrated), or connecting arrows, connecting rectangles, connecting triangles, or the like, which serve as a connecting pattern with a connecting function.

As shown in FIG. 6, the connecting pattern between the origin identifier 601 and the destination 602 may be divided based on a quantity (such as three) of flight phases (such as a takeoff phase, a level flight phase, and a descent phase) of the flight device between the origin and the destination, to obtain a plurality of connecting sub-patterns (such as a connecting line segment in region 1, a connecting line segment in region 2, and a connecting line segment in region 3 as shown in FIG. 6). The plurality of connecting patterns can be used to indicate the flight phases corresponding to the flight device when flying between the origin and the destination. For example, the connecting line segment in region 1 in FIG. 6 can indicate the takeoff phase of the flight device in a flight route, the connecting line segment in region 2 in FIG. 6 can indicate the level flight phase in the flight route, and the connecting line segment in region 3 in FIG. 6 can indicate the descent phase in the flight route.

It can be understood that, compared with displaying the connecting pattern between the origin and the destination on a map, in the embodiment shown in FIG. 6, the geographic location information of the origin and destination is not required to be carried, simplifying and emphasizing the displayed information through dimensionality reduction. In addition, the origin and destination can be arranged as needed, and a plurality of origins and destinations can be displayed in one display region through parallel or side-by-side arrangements. In summary, the technical solution for dimensionality reduction display provided in the embodiment shown in FIG. 6 allows flight device information of a plurality of flight devices to be displayed in one display region, thereby enabling concise and simultaneous display of information of the plurality of flight devices in one display region while emphasizing important reference information (such as flight device state information and flight phase information) during a flight device control process.

In some embodiments, a connecting sub-pattern corresponding to the takeoff phase may be connected to a first termination pattern (a first vertical line after the origin identifier 601 in FIG. 6). The first termination pattern is used to indicate an end of the ascent phase and a start of the level flight phase. One end of a connecting sub-pattern corresponding to the level flight phase is connected to the first termination pattern, and the other end thereof is connected to a second termination pattern (a second vertical line after the origin identifier 601 in FIG. 6). The second termination pattern is used to indicate an end of the level flight phase and a start of the descent phase. One end of a connecting sub-pattern corresponding to the descent phase is connected to the second termination pattern (the second vertical line after the origin identifier 601 in FIG. 6), and the other end thereof is connected to the destination identifier.

A start or an end of a flight phase can be clearly displayed by using the above first termination pattern, second termination pattern, and the like.

In some embodiments, the above flight phase indication information may also be used to indicate flight phases of the flight device in a flight route when departing from an origin, passing through a stopover, and heading toward a destination.

The origin and destination may be determined based on a specific application scenario. For example, in an aircraft navigation scenario, the above origin may be a departure location of the aircraft, the stopover may be a location at which the aircraft stops during the flight, and the above destination may be an arrival location of the aircraft.

In some embodiments, there may be one, two, or more stopovers, which is not limited in this disclosure.

For example, in a UAV delivery scenario, the origin may be a UAV's departure airport for a merchant, the destination may be a UAV's arrival airport for the merchant, and the stopover may be a user airport corresponding to a user waiting for delivery. One merchant may provide delivery to a plurality of users. Therefore, one UAV may stop at one, two, or more user airports during a single flight; or one UAV may stop at only one user airport during a single flight, but different UAVs may stop at different user airports.

In some embodiments, if the flight device passes through two or more stopovers sequentially while flying from the origin to the destination, those skilled in the art may extend the display solution for flight phase indication display corresponding to the flight device when stopping in a plurality of stopovers during a single flight based on the embodiment shown in FIG. 6.

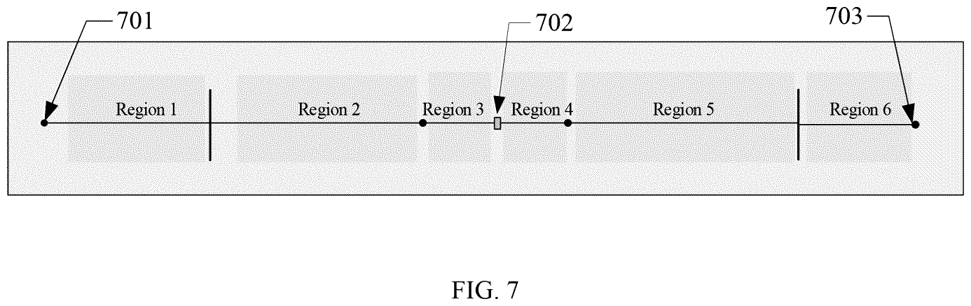

In some embodiments, if all flight devices flying from the origin to the destination stop at the same stopover, the flight phase indication information may be displayed in the following method: displaying an origin identifier (such as an origin identifier 701 shown in FIG. 7) corresponding to the origin, a stopover identifier (such as a stopover identifier 702 shown in FIG. 7) corresponding to the stopover, a destination identifier (such as a destination identifier 703 shown in FIG. 7) corresponding to the destination, and a connecting pattern (such as connecting lines connecting the origin 701, the stopover 702, and the destination 703 shown in FIG. 7) between the origin identifier, the stopover identifier, and the destination identifier. The connecting pattern is divided into a plurality of connecting sub-patterns based on flight phases corresponding to the flight device flying between the origin, the stopover, and the destination. The plurality of connecting sub-patterns are respectively used to indicate an origin takeoff phase, a first level flight phase, a stopover descent phase, a stopover takeoff phase, a second level flight phase, and a destination descent phase. As shown in FIG. 7, a connecting line segment in region 1 of FIG. 7 can indicate the origin takeoff phase, a connecting line segment in region 2 of FIG. 7 can indicate the first level flight phase, a connecting line segment in region 3 of FIG. 7 can indicate the stopover descent phase, a connecting line segment in region 4 of FIG. 7 can indicate the stopover takeoff phase, a connecting line segment in region 5 of FIG. 7 can indicate the second level flight phase, and a connecting line segment in region 6 of FIG. 7 can indicate the destination descent phase.

In some embodiments, if there are two stopovers between the origin and the destination, and one flight device passes through only one stopover while flying from the origin to the destination, different flight devices may pass through different stopovers while flying from the origin to the destination. In this case, the flight phase indication information may be displayed in the following method.

It should be noted that, in this application, a route passing through different stopovers between the origin and the destination can be considered a sub-flight route, and a flight route between the origin and the destination includes all sub-flight routes between the origin and the destination.

It should be noted that terms “flight route” and “sub-flight route” are essentially flight routes, and a difference in naming is merely to distinguish relationships thereof.

In some embodiments, connecting patterns displayed between the origin and the destination may include a first connecting pattern and a second connecting pattern. Stopovers between the origin and the destination may include a first stopover and a second stopover, and a plurality of connecting sub-patterns may include a first connecting sub-pattern and a second connecting sub-pattern. Therefore, the flight phase indication information may be displayed in the following method: displaying the first connecting pattern (representing one sub-flight route, which may also be referred to as a flight route) among the origin identifier, the first stopover identifier corresponding to the first stopover, and the destination identifier. The first connecting pattern is divided into a plurality of first connecting sub-patterns based on a flight phase of the flight device in a flight route in which the first stopover is located; and displaying the second connecting pattern (representing another sub-flight route) among the origin identifier, the second stopover identifier corresponding to the second stopover, and the destination identifier. The second connecting pattern is divided into a plurality of second connecting sub-patterns based on a flight phase of the flight device in a flight route in which the second stopover is located. Connecting sub-patterns corresponding to the same flight phase in the same aerial sub-flight route are merged for display.

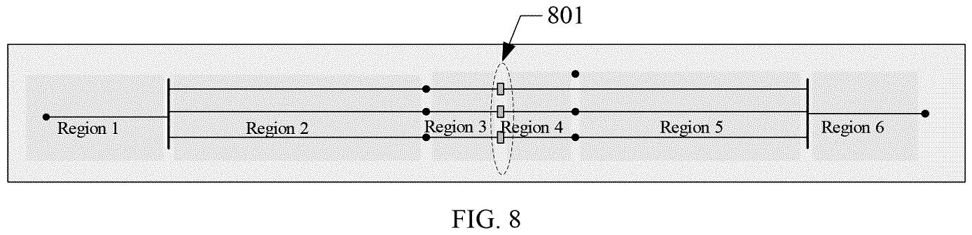

In some embodiments, if there are three stopovers between the origin and the destination, and one flight device passes through only one stopover while flying from the origin to the destination, different flight devices may pass through different stopovers while flying from the origin to the destination. In this case, the flight phase indication information may be displayed on an interface shown in FIG. 8.

As shown in FIG. 8, stopover identifiers (as indicated by 801 in FIG. 8) corresponding to three stopovers can be displayed in parallel between the origin identifier and the destination identifier. Subsequently, three connecting patterns are displayed between the origin identifier and the destination identifier, one of the three connecting patterns passes through a stopover. Then, the three connecting patterns are segmented based on flight phases of the flight device between the origin, the stopover, and the destination to obtain a plurality of connecting sub-patterns. Connecting sub-patterns in different sub-flight routes can indicate flight phases in the sub-flight routes.

In some embodiments, when the above connecting sub-patterns are displayed, the connecting sub-patterns corresponding to flight phases in the same aerial flight routes (regardless of flight direction) can be merged for display. As shown in FIG. 8, aerial flight routes corresponding to takeoff phases in sub-flight routes in which the three stopovers are located may be the same. In this case, connecting sub-patterns corresponding to the takeoff phases in the sub-flight routes in which the three stopovers are located can be merged for display (a specific merging method is not limited in this disclosure). The flight phase indication information is displayed in the above method, so that whether various flight devices are in the same sub-flight route can be clearly known, thereby avoiding interference with normal flight of other flight devices in the same sub-flight route when a flight device is controlled.

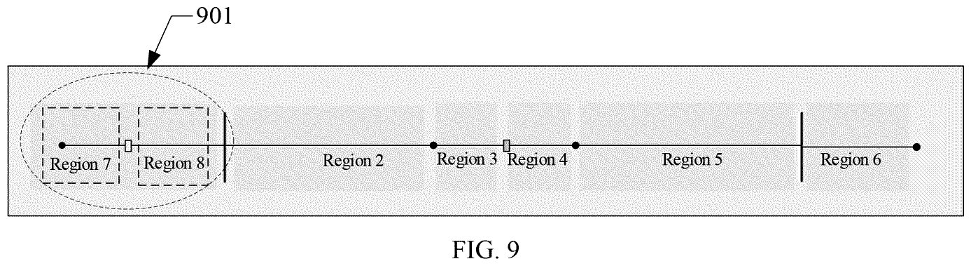

In some embodiments, origin takeoff phase indication information (such as the connecting sub-pattern in region 1 of FIG. 7) corresponding to the origin takeoff phase can be further subdivided based on takeoff actions of the flight device at a takeoff location. For example, the takeoff actions of the flight device at the takeoff location may include a sub-phase of moving towards an airport and a sub-phase of taking off from the airport. In this case, the origin takeoff phase indication information in FIG. 7 can be divided into two parts (such as a part corresponding to region 7 and a part corresponding to region 8 in identifier 901 of FIG. 9). One part (such as a connecting line segment in region 7 of FIG. 9) can indicate a sub-phase of the flight device moving towards the airport, while the other part (such as a connecting line segment in region 8 of FIG. 9) indicates a sub-phase of the flight device taking off from the airport.

In some embodiments, there may be one, two, or more airports corresponding to the origin. Accordingly, there are also one, two, or more origin identifiers corresponding to the origin.

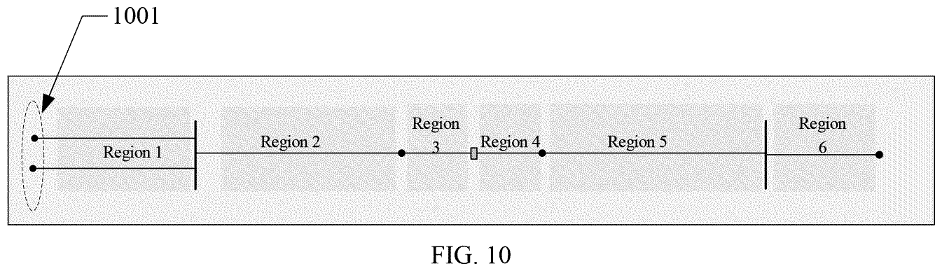

In some embodiments, the origin may include a first airport and a second airport, and the origin identifier may include a first airport identifier corresponding to the first airport in the origin and a second airport identifier corresponding to the second airport in the origin. In this case, the first airport identifier (such as one identifier in 1001 of FIG. 10) and the second airport identifier (such as the other identifier in 1001 of FIG. 10) can be displayed at a location of the origin identifier (such as the origin identifier 701 shown in FIG. 7). Subsequently, the first airport identifier and the second airport identifier are separately displayed to be connected to the destination identifier respectively through the connecting patterns, and the above connecting patterns can be segmented based on flight phases of the flight device.

In some embodiments, when the above connecting sub-patterns are displayed, connecting sub-patterns corresponding to flight phases in the same aerial flight routes can be merged for display. For example, for a sub-flight route in which the first airport is located and a sub-flight route in which the second airport is located, aerial flight routes corresponding to takeoff phases are different, but flight routes corresponding to other flight phases are entirely the same. Therefore, connecting sub-patterns corresponding to flight phases other than the origin takeoff phases can be merged for display, as shown in FIG. 10.

In the above method, not only are the different takeoff phases in the sub-flight routes corresponding to different airports distinctly displayed, but also the connecting sub-patterns corresponding to flight phases with the same aerial flight routes are merged for display. This allows a target object to promptly know flight devices in the same aerial flight route and to distinguish flight devices in different sub-flight routes in a timely manner, thereby enabling control of flight devices based on aerial flight routes, sequence, and the like of the flight devices.

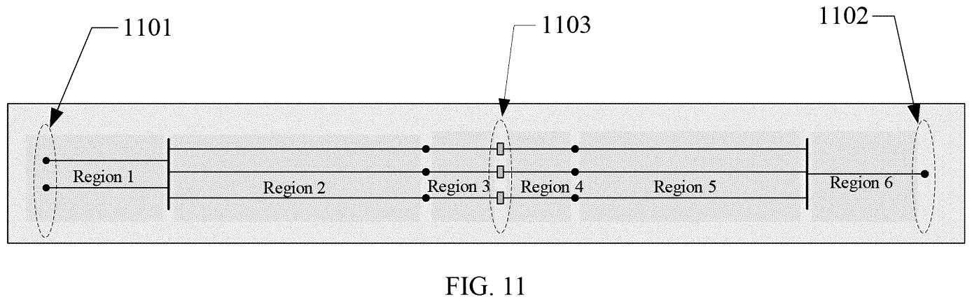

In some embodiments, in one application scenario, the origin may be corresponding to a plurality of airports, and there may be a plurality of stopovers between the origin and the destination. A technical solution corresponding to a scenario in which there is a plurality of airports in the origin and a technical solution corresponding to a scenario in which there are a plurality of stopovers between the origin and the destination, so that a schematic diagram of flight phase indication information as shown in FIG. 11 can be obtained. In the schematic diagram shown in FIG. 11, the origin may be provided with two airport identifiers (such as two solid circles indicated by 1101), the destination may be provided with one destination identifier (such as a single solid circle indicated by 1102), and there may be three stopovers (such as three rectangles indicated by 1103) between the origin and the destination. Connecting patterns among the origin, the stopovers, and the destination are segmented based on flight phases of the flight device between the origin and the destination. Additionally, connecting sub-patterns corresponding to flight phases with the same aerial flight route are merged for display.

In the above display method, sub-flight routes, flight phases, and the like of the flight device can be refined and prominently displayed. Moreover, when the flight phases are displayed, the connecting sub-patterns corresponding to flight phases with the same aerial flight route are merged for display. This enables a spatial relationship of flight devices in the same sub-flight route to be displayed when the flight phases of the flight devices are displayed, thereby avoiding interference with nearby flight devices when one flight device is controlled.

It should be noted that the regions 1 (2, 3, and the like) and corresponding shaded parts in FIG. 6 to FIG. 11 are marked for ease of explaining the technical solutions and may not be displayed in actual applications.

In some embodiments, the above flight phase indication information can be displayed based on a geographic range of a flight route. In some embodiments, the geographic range in this disclosure may be a country, province, city, street, business district, or the like, which can be determined by those skilled in the art based on needs.

In some embodiments, the first information display region may include a first geographic display sub-region corresponding to a first geographic range and a second geographic display sub-region corresponding to a second geographic range. The flight route of the flight device may include a first flight route and a second flight route. There may be one flight route between one origin and one destination, and this flight route may further include a plurality of sub-flight routes. As shown in FIG. 6 to FIG. 11, there is only one flight route between one origin and one destination, and this flight route may include one, two, or a plurality of sub-flight routes. One route is corresponding to one origin and one destination, and different sub-flight routes pass through different stopovers.

In some embodiments, the displaying flight phase indication information may include: if the first flight route is within the first geographic range and the second flight route is within the second geographic range, displaying flight phase indication information corresponding to the first flight route and/or flight environment information within the first geographic range in a first geographic display sub-region, and displaying flight phase indication information corresponding to the second flight route and/or flight environment information within the second geographic range in a second geographic display sub-region. If the first flight route and the second flight route are both within the first geographic range, the flight phase indication information corresponding to the first flight route, the flight phase indication information corresponding to the second flight route, and/or the flight environment information within the first geographic range are displayed in the first geographic display sub-region.

As shown in FIG. 12, flight phase indication information of different flight routes can be displayed based on geographic ranges. For example, flight phase indication information (such as a flight route indicated by 1201 in FIG. 12) for a flight route within the first geographic range can be displayed in a display sub-region (such as a region corresponding to a name of the first geographic range in FIG. 12) corresponding to the first geographic range, as shown in 1205 in FIG. 12, and a name corresponding to the geographic range can be displayed within the display sub-region. Flight phase indication information (such as a flight route indicated by 1202 in FIG. 12) in a flight route within the second geographic range can be displayed within a display sub-region (such as a region corresponding to the second geographic range in FIG. 12) corresponding to the second geographic range. Flight phase indication information in a route within a third geographic range can be displayed within a display sub-region corresponding to the third geographic range. There may be a plurality of flight routes (such as a flight route indicated by 1203 and a flight route indicated by 1204 in FIG. 12, where flight routes with different origins can be distinctly displayed) within the third geographic range, and the like.

In some embodiments, weather corresponding to a geographic range can also be displayed within the display sub-region of the geographic range. For example, weather information within the second geographic range is displayed at a location indicated by 1207 in FIG. 12. Weather conditions within a geographic range can be promptly known by displaying the weather information, thereby assisting in determining how to control a flight device. For example, under adverse weather conditions, takeover control and the like can be performed on a flight device within the geographic range.

In some embodiments, a work shift control element (such as a control element indicated by 1206 in FIG. 12) can also be displayed within a display sub-region corresponding to a geographic range. Through this work shift control element, it can be determined whether to display flight device information within the geographic range. If the work shift control element is in an off-duty state, the flight device within the corresponding geographic range is not displayed.

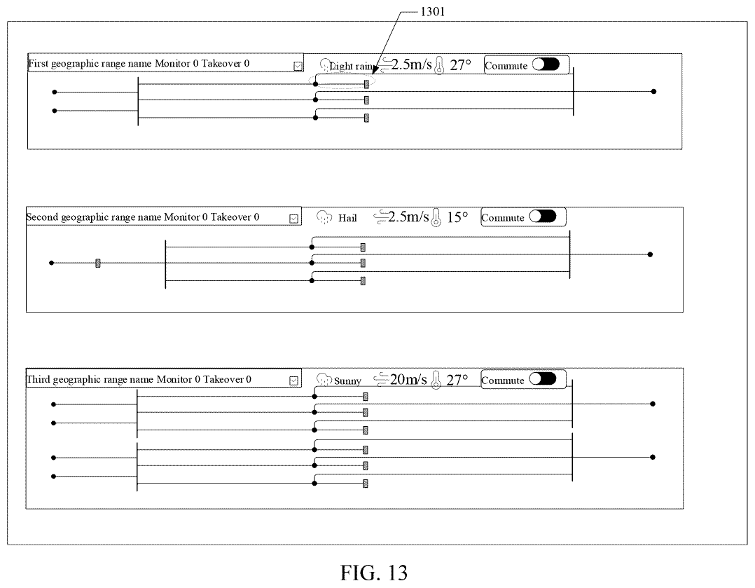

Merging connecting sub-patterns corresponding to flight phases with the same aerial flight sub-flight route for display is also proposed in this disclosure. A flight direction may not be considered, but a spatial route is only considered for the flight sub-flight route. If two sub-flight routes have opposite flight directions but the same aerial flight trajectory, an aerial flight route thereof is considered to be the same. It can be understood that when there is a stopover between the origin and the destination, a stopover descent phase and a stopover takeoff phase of the flight device at the stopover are completed within same space. In this case, a flight device taking off or descending within the space may influence each other. For example, a connecting sub-pattern (such as a connecting sub-pattern indicated by 1208 in FIG. 12) corresponding to the stopover descent phase and the stopover takeoff phase in FIG. 12 can be merged to generate a new connecting sub-pattern (such as merged into a pattern indicated by 1301 in FIG. 13) for display. Therefore, when a flight device during the stopover takeoff phase (or stopover descent phase) is controlled, not only the flight device in the stopover takeoff phase is considered, but also a flight device in the stopover descent phase is considered. This avoids, when a flight device is controlled, affecting normal flight of other flight devices within space in which the flight device is located, to prevent a flight accident.

Next, a way for displaying a device identifier of the flight device is described in this disclosure by combining flight phase indication information shown in FIG. 5 or FIG. 13. Those skilled in the art can replace flight phase indication information in the following embodiment with another piece of flight phase indication information (such as any flight phase indication information from FIG. 5 to FIG. 13), which is not limited in this disclosure.

In some embodiments, if a current flight phase of a flight device is a takeoff phase, a device identifier (such as a device identifier 3301) of the flight device can be displayed in a box of a takeoff phase shown in FIG. 5. Alternatively, the device identifier of the flight device can be displayed near a line segment (for indicating the takeoff phase) in region 1 shown in FIG. 6. Alternatively, the device identifier of the flight device can be displayed before a phase identifier 603 shown in FIG. 6, and the like, which is not detailed in this disclosure.

In some embodiments, when the device identifier of the flight device is displayed, a current flight route of the flight device can also be considered. The device identifier of the current device can be displayed at a location corresponding to a current flight phase of a current flight route of the flight device.

In some embodiments, as shown in FIG. 14, if a flight device indicated by 1403 and a flight device indicated by 1404 are in different flight phases of the same flight route, the device identifier indicated by 1403 and the device identifier indicated by 1404 can be displayed at different locations of flight phase indication information shown in FIG. 14. For example, as shown in FIG. 14, if the flight device indicated by 1401 (or 1402) and the flight device indicated by 1403 (or 1404) are in different flight routes, the device identifier corresponding to 1401 (or 1402) and the device identifier corresponding to 1402 (or 1404) can be displayed in different flight routes shown in FIG. 14.

In some embodiments, the flight devices can be displayed at associated locations of the flight phase indication information corresponding to the same flight phase, in order in which the flight devices are in the same flight phase.

For example, the flight devices may include a second flight device and a third flight device. Therefore, displaying the device identifiers of flight devices at associated locations of the flight phase indication information corresponding to the current flight phase of the flight devices may include: if current flight routes and current flight phases of the second flight device and the third flight device are the same, displaying device identifiers of the second flight device and the third flight device in order, in which the second flight device and the third flight device are in the current flight phase, at an associated location of the current flight phase in the current flight route. For example, the device identifier of the second flight device may be displayed before the device identifier of the third flight device. For example, as shown in FIG. 14, if the flight device represented by the device identifier indicated by 1404 is in a current driving phase (such as a second level flight phase corresponding to the second stopover) of the current flight route earlier than the flight device represented by the device identifier indicated by 1403, the device identifier indicated by 1404 is displayed ahead of the device identifier indicated by 1403 in the current driving phase of the current flight route.

In the above display method, a device identifier of a flight device that is in a current driving phase earlier during an actual flight process can also be displayed in the front. This allows the target object to know a relative spatial location of a flight device based on a location of a device identifier of the flight device, thereby determining, based on a relative location of the flight device, which flight device to be taken over and controlled. For example, it is assumed that a device identifier 1 and a device identifier 2 are displayed at an associated location of the flight phase indication information corresponding to the same takeoff phase, and the device identifier 1 is ahead of the device identifier 2. It can be determined that a flight device corresponding to the device identifier takes off earlier than a flight device corresponding to the device identifier 2. If flight devices corresponding to the device identifier 1 and the device identifier 2 are to be controlled, the flight device corresponding to the device identifier 2 can be considered first, to avoid affecting the flight device corresponding to the device identifier 1 while the flight device corresponding to the device identifier 2 is controlled.

In the display method provided in this embodiment, a plurality of flight devices can be managed simultaneously, to accurately identify current flight routes and current flight phases of the flight devices, as well as sequential locations of various flight devices in the same flight route and same flight phase, thereby enabling control of the flight devices.

In a current UAV management solution, motion trajectories of UAVs are laid out side by side on a two-dimensional map, and it is determined whether the UAVs are operating normally by observing these trajectories and UAV alert information. However, this solution has obvious limitations, and a user can observe only a limited quantity of UAVs and cannot intuitively know flight phases of the UAVs. In this embodiment, dimensionality reduction design is used, to enable the target object to manage a plurality of UAVs simultaneously. In addition, in this embodiment, operational phases of the UAVs are split, to enable the target object to accurately identify flight phases of the UAVs and to facilitate the target object to focus on a required flight phase and a sequential order of different flight devices within the same flight phase.

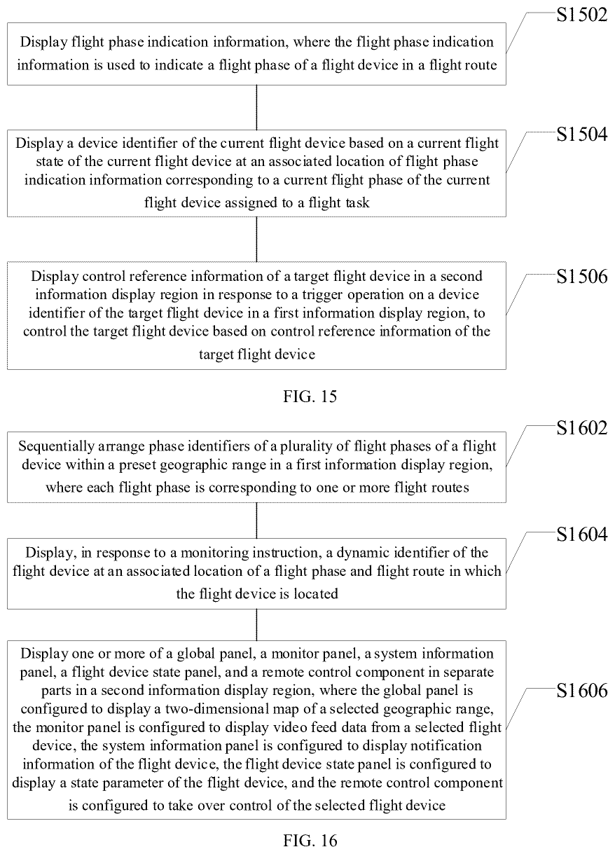

FIG. 15 is a flowchart illustrating a control reference information display method for a flight device according to an exemplary embodiment. Refer to the method shown in FIG. 15. The control reference information display method may include the following steps.

Step S1502: Display flight phase indication information, where the flight phase indication information is used to indicate a flight phase of a flight device in a flight route. Step S1504: Display a device identifier of the flight device based on a current flight state of the flight device at an associated location of the flight phase indication information corresponding to the current flight phase of the flight device assigned to a flight task. Step S1506: Display control reference information of a target flight device in a second information display region in response to a trigger operation on a device identifier of the target flight device in a first information display region, to control the target flight device based on control reference information of the target flight device.

In some embodiments, a terminal device may display the first information display region and a second information display region. The first information display region and the second information display region can be displayed in different locations or in the same location within the same display window, or be displayed in different display windows. The different windows can be displayed on different screens or on the same screen, which is not limited in this disclosure.

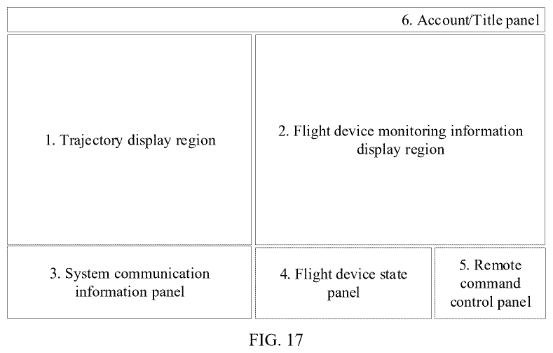

In some embodiments, the flight phase indication information and the device identifier of the flight device can be displayed within the first information display region. The control reference information of the flight device can be displayed within the second information display region (such as a region in FIG. 17).

FIG. 16 is a flowchart illustrating a flight device information display method according to an exemplary embodiment. Refer to FIG. 16. The flight device information display method may include the following steps. Step S1602: Sequentially arrange phase identifiers of a plurality of flight phases of a flight device within a preset geographic range in a first information display region, where each flight phase is corresponding to one or more flight routes. Step S1604: Display, in response to a monitoring instruction, a dynamic identifier of the flight device at an associated location of a flight phase and a flight route in which the flight device is located. Step S1606: Display one or more of a global panel, a monitor panel, a system information panel, a flight device state panel, and a remote control component in separate parts in a second information display region, where the global panel is configured to display a two-dimensional map of a selected geographic range, the monitor panel is configured to display video feed data from a selected flight device, the system information panel is configured to display notification information of the flight device, the flight device state panel is configured to display a state parameter of the flight device, and the remote control component is configured to take over control of the selected flight device.

As shown in FIG. 17 one or more of the global panel (such as a trajectory display region), the monitor panel (such as a flight device monitoring information display region), the system information panel (such as a system communication information panel), the flight device state panel (such as a flight device state panel), and the remote control component (such as a component within the remote command control panel) are displayed in separate parts in the second information display region where the global panel is configured to display a two-dimensional map of a selected geographic range, the monitor panel is configured to display video feed data from a selected flight device, the system information panel is configured to display notification information of the flight device, the flight device state panel is configured to display a state parameter of the flight device, and the remote control component is configured to take over control of the selected flight device.

In some embodiments, in response to a selection operation on a dynamic identifier or static identifier of the target flight device, the video feed data from the target flight device can be displayed on the monitor panel, and a dynamic flight trajectory of a flight device within a selected geographic range can be displayed on a two-dimensional map.

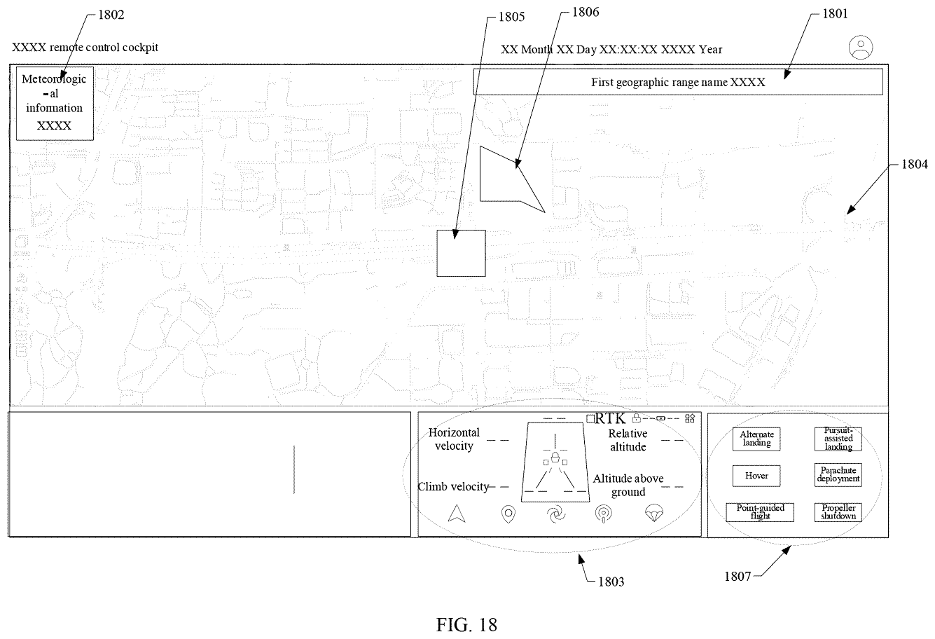

In some embodiments, the layout of the second information display region may be shown in FIG. 17, but any layout capable of displaying control reference information falls within the scope of this disclosure. In some embodiments, information can be pre-filled in FIG. 17 to generate a schematic diagram shown in FIG. 18. FIG. 18 is a schematic diagram illustrating an interface when no display task is received, according to an exemplary embodiment. In the interface shown in FIG. 18, a geographic range name display region indicated by 1801, a meteorological information display region within a geographic range indicated by 1802, a device state display region indicated by 1803, a map indicated by 1804, a no-fly zone on a map indicated by 1805, a no-stop zone on a map indicated by 1806, and an inactive control element indicated by 1807, and a region without information can be displayed as empty.

In some embodiments, the flight device may include a target flight device. In some embodiments, the flight device in the first information display region can be triggered to view control reference information of the flight device, to control the flight device.

The control reference information of the target flight device may be information that serves as a reference when the target flight device is controlled. The control reference information of the target flight device may include information about the target flight device or information except the target flight device, which is not limited in this disclosure.

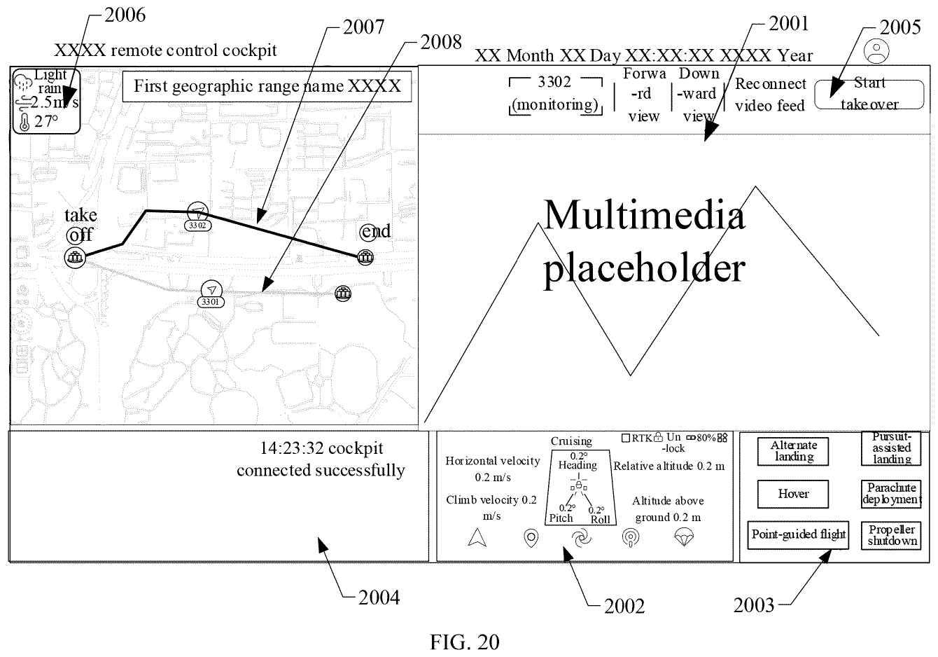

In some embodiments, the terminal device may display, in response to a trigger operation on a device identifier of the target flight device in the first information display region, the control reference information of the target flight device within the second information display region (as shown in FIG. 18) (Reference may be made to a schematic diagram shown in FIG. 20 for a specific display effect), to control the target flight device based on the control reference information of the target flight device.

In some embodiments, the control reference information of the target flight device may include flight trajectory information of the target flight device displayed on a map in the second information display region, and/or multimedia information collected by the target flight device displayed in the second information display region, and/or device state information of the target flight device displayed in the second information display region.

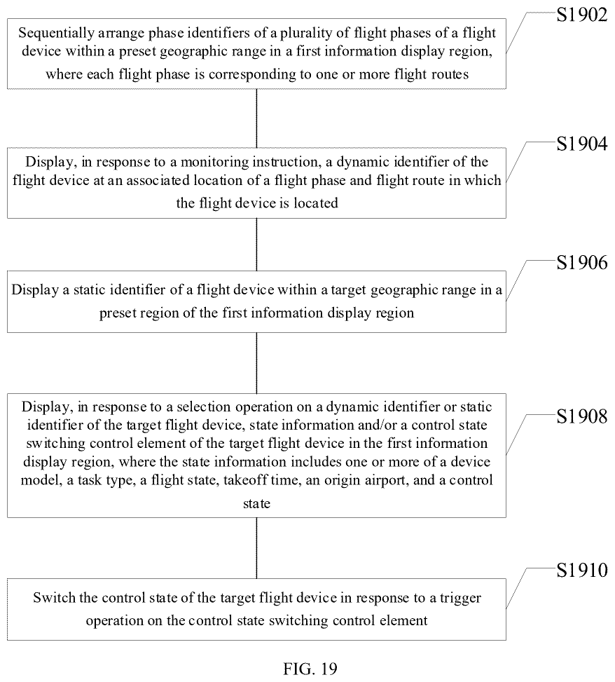

FIG. 19 is a flowchart illustrating a flight device information display method according to an exemplary embodiment. Refer to FIG. 19. The flight device information display method may include the following steps. Step S1902: Sequentially arrange phase identifiers of a plurality of flight phases of a flight device within a preset geographic range in a first information display region, where each flight phase is corresponding to one or more flight routes. The preset geographic range may include a target geographic range. Step S1904: Display, in response to a monitoring instruction, a dynamic identifier of the flight device at an associated location of a flight phase and flight route in which the flight device is located. Step S1906: Display a static identifier of a flight device within a target geographic range in a preset region of the first information display region. Step S1908: Display, in response to a selection operation on the dynamic identifier or static identifier of the target flight device, state information and/or a control state switching control element of the target flight device in the first information display region, where the state information includes one or more of a device model, a task type, a flight state, takeoff time, an origin airport, and a control state.

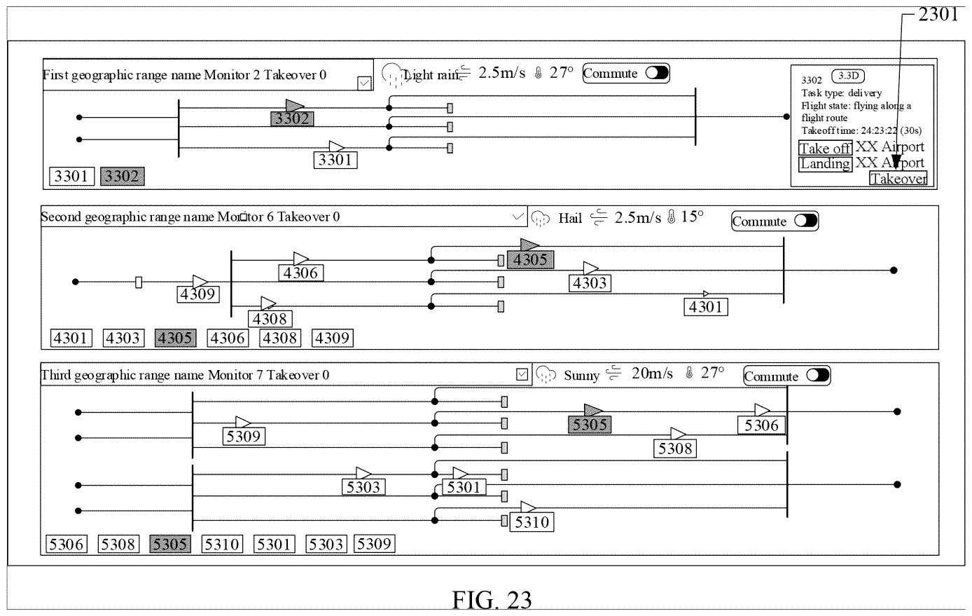

As shown in FIG. 23, the state information and/or control state switching control element (such as “takeover” control element 2301) of the target flight device can be displayed in the first information display region. The state information includes one or more of a device model, a task type, a flight state, takeoff time, an origin airport, and a control state.

Step S1910: Switch the control state of the target flight device in response to a trigger operation on the control state switching control element.

In some embodiments, switching the control state of the target flight device includes switching the control state of the target flight device to a takeover state. In response to a trigger operation on the control state switching control element, the method further includes: activating a remote control component to control the target flight device (such as activating control components such as “alternate landing” and “hover” for the target device in FIG. 20).

In some embodiments, after the device identifier of the target flight device is triggered in the first information display region, control reference information of the target flight device can be displayed on a display interface shown in FIG. 20.

As shown in FIG. 20, multimedia information (such as a video captured by a video collector during flight of the flight device) collected by the target flight device can be displayed at a location indicated by 2001; device state information corresponding to the target flight device can be displayed at a location indicated by 2002; and an activated control element or a non-activated control element can be displayed at a location indicated by 2003, where the activated control element can be configured to control the target flight device. Warning information of the target flight device can be displayed at a location indicated by 2004. A “start takeover” control element can be displayed at a location indicated by 2005, and the target flight device can be taken over and controlled through the “start takeover” control element. Meteorological information within a geographic range of the target flight device can be displayed at a location indicated by 2006. A flight trajectory of the flight device within the geographic range of the target device can be displayed on the map, such as a flight trajectory of a target flight device indicated by 2007 and a flight trajectory of another flight device within a geographic range of a target flight device indicated by 2008.

In some embodiments, the flight device may further include a plurality of first flight devices, where the plurality of first flight devices and target flight devices can be disposed to fly within the same geographic range.

The displaying control reference information of a target flight device in a second information display region in response to a trigger operation on a device identifier of the target flight device in a first information display region includes: displaying the control reference information of the target flight device and at least some of the control reference information of the first flight device in the second information display region in response to the trigger operation on the device identifier of the target flight device in the first information display region, to control the target flight device based on at least some of the control reference information of the first flight device and the control reference information of the target flight device.

In some embodiments, the at least some of the control reference information of the first flight device may include flight trajectory information of the first flight device displayed on a map of the second information display region.

As shown in FIG. 20, a flight trajectory (such as a flight trajectory indicated by 2007) of the selected target flight device can be displayed in a selected state (such as displayed in a dark color to indicate the selected state), while a flight trajectory (such as a flight trajectory indicated by 2008) of an unselected first flight device can be displayed in an unselected state (such as displayed in a light color to indicate the unselected state).

In some embodiments, the control reference information of the target flight device displayed in the second information display region can be switched to the control reference information of the first flight device by triggering the flight trajectory of the first device on the map of the second information display region. The device identifier of the first flight device in the first information display region can also be triggered to switch the control reference information of the target flight device displayed in the second information display region to the control reference information of the first flight device.

In some embodiments, the terminal device may display the control reference information of the first flight device in the second information display region in response to a trigger operation on the flight trajectory information of the first flight device in the second information display region, switch the flight trajectory information of the first flight device from an unselected state to a selected state on the map, and switch the flight trajectory information of the target flight device from a selected state to an unselected state.

In some embodiments, the terminal device may display the control reference information of the first flight device in the second information display region in response to a trigger operation on the device identifier of the first flight device in the first information display region, switch the flight trajectory information of the first flight device from an unselected state to a selected state on the map, and switch the flight trajectory information of the target flight device from a selected state to an unselected state.

In some embodiments, remote control elements (such as an alternate landing control element, a hover control element, and a parachute deployment control element indicated by 2003 in FIG. 20) for the flight device may be displayed in the second information display region.

In some embodiments, when the device identifier corresponding to the target flight device is triggered, the control elements in the second information display region may either be activated or remain non-activated (non-activated control elements shown in FIG. 20).

The activated control element can be configured to control a triggered target flight device.

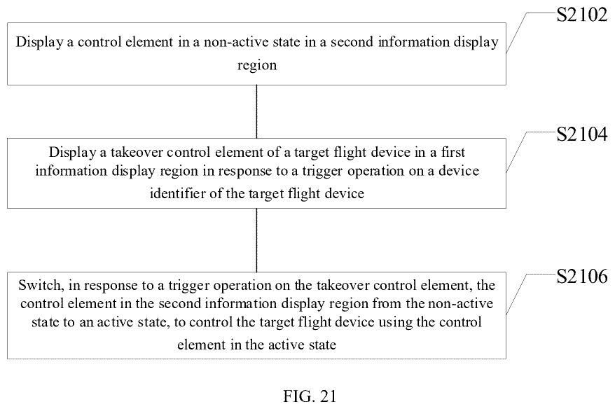

In some embodiments, the control element can be activated by triggering a takeover control element (such as the “start takeover” control element indicated by 2005 in FIG. 20) corresponding to the target flight device in the second information display region, so that the triggered target flight device is controlled through the control element. The control element can alternatively be activated in the method shown in FIG. 21.

FIG. 21 is a flowchart illustrating a control element activation method according to an exemplary embodiment. Refer to FIG. 21. The above control element activation method may include the following steps. Step S2102: Display a control element in a non-active state in a second information display region. Step S2104: Display a takeover control element of a target flight device in a first information display region in response to a trigger operation on a device identifier of the target flight device.

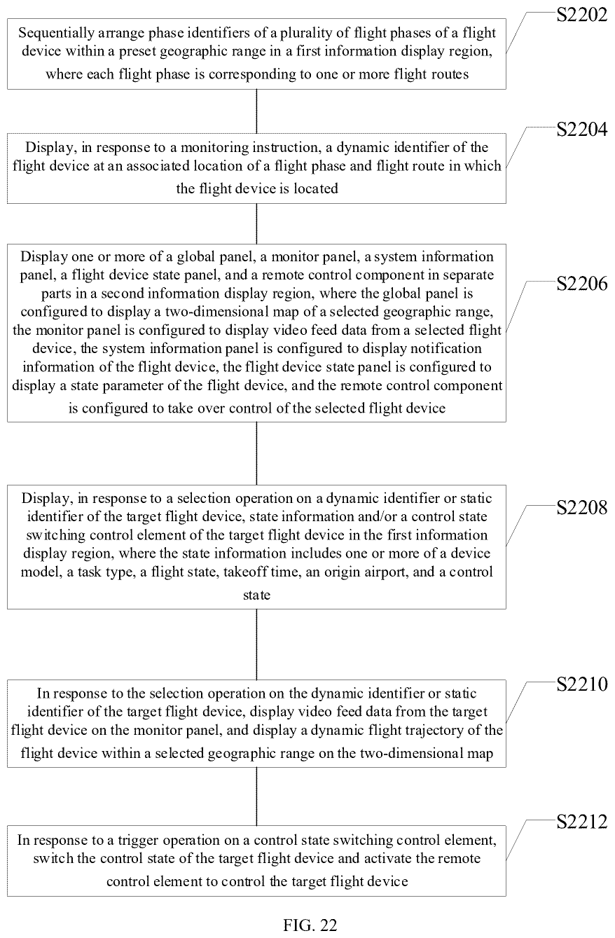

FIG. 22 is a flowchart illustrating a flight device information display method according to an exemplary embodiment. Refer to FIG. 22. The flight device information display method may include the following steps. Step S2202: Sequentially arrange phase identifiers of a plurality of flight phases of a flight device within a preset geographic range in a first information display region, where each flight phase is corresponding to one or more flight routes. Step S2204: Display, in response to a monitoring instruction, a dynamic identifier of the flight device at an associated location of a flight phase and flight route in which the flight device is located. Step S2206: Display one or more of a global panel, a monitor panel, a system information panel, a flight device state panel, and a remote control component in separate parts in a second information display region, where the global panel is configured to display a two-dimensional map of a selected geographic range, the monitor panel is configured to display video feed data from a selected flight device, the system information panel is configured to display notification information of the flight device, the flight device state panel is configured to display a state parameter of the flight device, and the remote control component is configured to take over control of the selected flight device. Step S2208: Display, in response to a selection operation on the dynamic identifier or static identifier of the target flight device, state information and/or a control state switching control element of the target flight device in the first information display region, where the state information includes one or more a device model, a task type, a flight state, takeoff time, an origin airport, and a control state. Step S2210: In response to the selection operation on the dynamic identifier or static identifier of the target flight device, display video feed data from the target flight device on the monitor panel, and display a dynamic flight trajectory of the flight device within a selected geographic range on the two-dimensional map. Step S2212: In response to a trigger operation on a control state switching control element, switch the control state of the target flight device and activate the remote control element to control the target flight device.

Next, in this disclosure, the flight device information display method proposed in this disclosure is explained and described in an application scenario of UAV (a type of flight device) delivery.

In some embodiments, there are a plurality of flight devices, which may include a target flight device. The method may further include: displaying, in response to a selection operation on a dynamic identifier or static identifier of the target flight device, state information and/or a control state switching control element of the target flight device in the first information display region, where the state information includes one or more of a device model, a task type, a flight state, takeoff time, an origin airport, and a control state.

In some embodiments, the above flight device information display method may include: switching the control state of the target flight device in response to a trigger operation on the control state switching control element.

In some embodiments, the target object can trigger an identifier of the target flight device in the first information display region, and then the terminal device can display a takeover control element of the target flight device in the first information display region in response to a trigger operation on the device identifier of the target flight device. As shown in FIG. 23, if a device identifier 3302 is triggered, state information and/or control state switching control element (such as a control element indicated by 2301) of a flight device corresponding to the device identifier 3302 can be displayed.

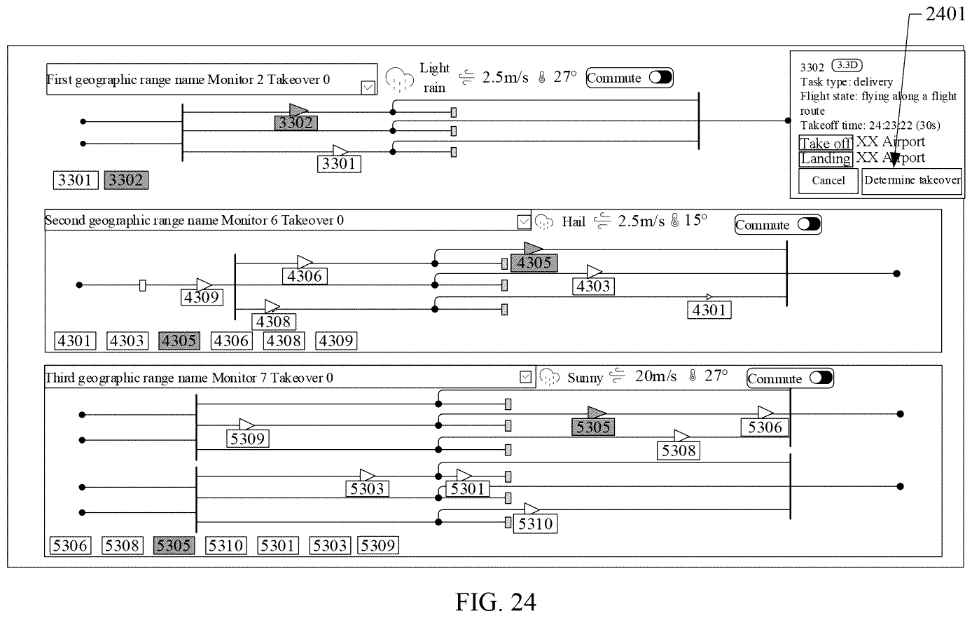

In some embodiments, after the “takeover” control element is triggered, a “takeover determining” control element indicated by 2401 shown in FIG. 24 is also displayed in response to a trigger operation on the “takeover” control element.

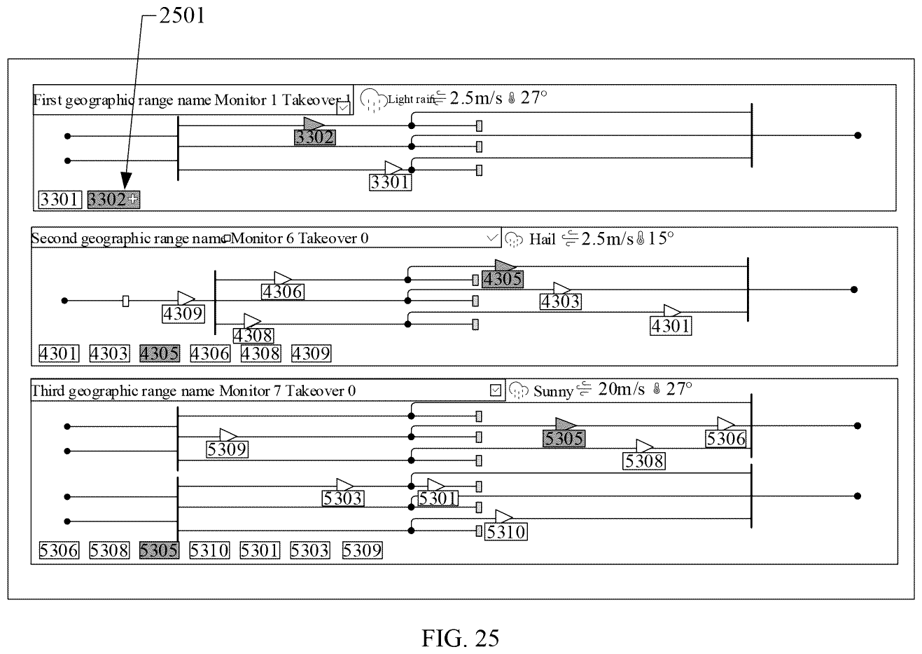

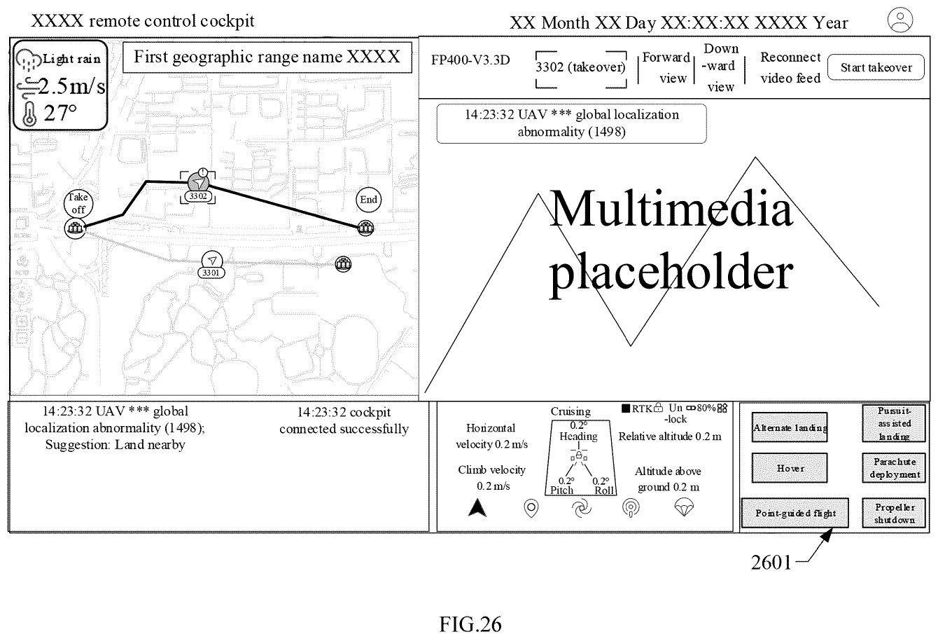

The target object can trigger the takeover control element (either the “takeover” control element shown in FIG. 23 or the “takeover determining control element” shown in FIG. 24) in the first information display region. The terminal device displays the device identifier of the target flight device in a takeover state in the first information display region in response to the trigger operation on the takeover control element (as shown in FIG. 25, a “+” symbol occurs on an upper right corner of a device identifier indicated by 2501, and the “+” represents that a flight device corresponding to the device identifier indicated by 2501 has been taken over), and switches a control element in the second information display region from a non-active state (2003 in FIG. 20 indicates the control element in the active state) to an active state (2601 in FIG. 26 indicates the control element in the active state), so that the control element in the active state can be configured to control the target flight device.

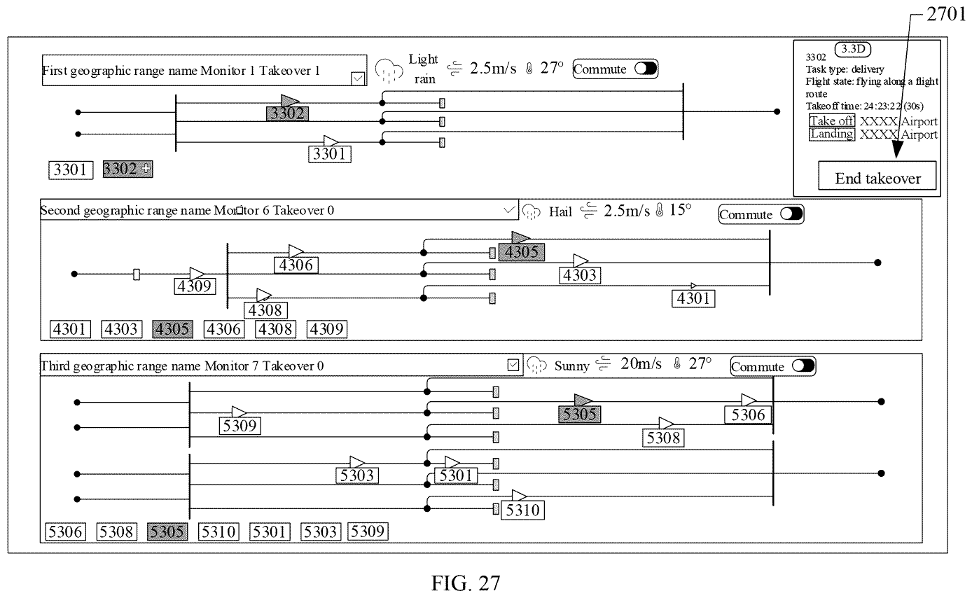

In some embodiments, when the device identifier of the taken-over flight device is triggered in the first information display region, a “takeover ending” control element (such as a “takeover ending” control element indicated by 2701 in FIG. 27) of the taken-over flight device may also be displayed. Takeover of the flight device can be ended by using the “takeover ending” control element, and a control element corresponding to the flight device whose takeover has ended can be switched from an active state to a non-active state.

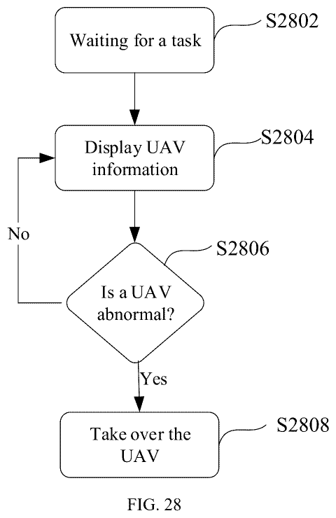

FIG. 28 is a flowchart illustrating an (Unmanned Aerial Vehicle) UAV device information display method according to an exemplary embodiment. Refer to FIG. 28. The above UAV device display method may include the following steps.

Step S2802: Wait for a task.

In some embodiments, waiting for a task may mean waiting for a UAV to accept the task. When the UAV receives a flight delivery task, a terminal device receives a display task of the UAV that has accepted the delivery task. In some embodiments, an interface for managing the UAV can be divided into a main screen and a secondary screen. During a task waiting phase (when the UAV is waiting for the delivery task), display of the main screen is shown in FIG. 18, and display of the secondary screen is shown in FIG. 13. Meteorological data, virtual resources (such as a no-fly zone and a no-stop zone), an airport device, and the like for a currently selected business district (a business district may be a geographic range) are displayed on the main screen (as shown in FIG. 18), and a part without data is displayed as blank.

Business districts that the target object needs to manage are laid out side by side for display on the secondary screen, allowing a user to manage a plurality of UAVs in different business districts simultaneously. The concept of dimensionality reduction design is used for the secondary screen, and flight routes of the UAVs are designed in a two-dimensional manner. A specific rule is to draw the flight routes of the UAVs in each commercial district in a time sequence (such as a time sequence of reaching a specific flight phase), and the flight routes are divided into different phases. As shown in FIG. 13, there may be one, two, or a plurality of flight routes in a commercial district, and one flight route can be divided into a plurality of sub-flight routes. Each sub-flight route can be divided into a UAV's takeoff and ascent phase from a merchant airport, a UAV's level flight phase, a UAV's precise descent phase to a user's airport, a UAV's takeoff and ascent phase from the user's airport, a UAV's level flight phase, and a UAV's precise descent phase to the merchant airport. In some embodiments, in a three-phase meal delivery mode, the UAV's takeoff and ascent phase from the merchant airport can be further divided into a UAV's meal pickup phase and a UAV's ascent phase. In this division method, a more precise UAV flight phase management service can be provided to a target object.

Step S2804: Display UAV information.

When the UAV receives a flight delivery task, a terminal device receives a UAV information display task of a UAV that has accepted the delivery task. When the UAV information display task is received, display of the main screen is shown in FIG. 14, and display of the secondary screen is shown in FIG. 20. As shown in FIG. 20, a display region on the secondary screen can be divided into six regions. Region 1 is a trajectory display region, where elements such as a UAV and flight route in a currently selected commercial district are rendered. Region 2 is a flight device monitoring information display region, where real-time video feed information from the UAV is displayed, and operations such as switching the UAV are supported. Region 3 is a system communication information panel, which displays a UAV alarm and UAV notification information. Region 4 is a flight device state panel, which displays various state parameters of the UAV. Region 5 is a remote command control panel, which integrates UAV control instructions. Region 6 is an account/title panel, which displays personal information and the like. The secondary screen displays an actual operation state of UAVs in each commercial district, and the UAVs include a selected state (green), an abnormal state (UAV encountering a type 1 alarm (red) or a type 2 alarm (yellow)).

Step S2806: Determine whether the UAV is abnormal?

If it is determined, based on a device identifier of the UAV, that there is no abnormal UAV, step S2804 is performed repeatedly.

If it is determined, based on the device identifier of the UAV, that there is an abnormal UAV in flight, step S2808 is performed to take over the abnormal UAV.

In some embodiments, the target object can select a UAV by clicking a static identifier or dynamic identifier in a UAV list on the secondary screen to view detailed UAV information, while integrating a selected video feed from the UAV to the main screen for display. When a UAV is in an abnormal state, the abnormality can be promptly detected and selected through the secondary screen, and the UAV is taken over. After being taken over, the UAV can be operated on the main screen.

In some embodiments, if it is determined, based on the identifier corresponding to the UAV, that the UAV is in an abnormal state (which may be a device abnormality, a trajectory abnormality, or a weather abnormality), it is determined whether to take over the abnormal UAV based on a flight phase of the UAV and a sequence of a plurality of UAVs in flight phase.

After taking over the UAV, the user can issue an instruction to the current UAV to ensure that the UAV lands safely. Once the UAV lands safely, the user may exit from the takeover to end a management process for the UAV.

In the above embodiments, a flight route map is divided and displayed by flight phases, and UAV information is displayed in a dimensionality reduction manner, enabling the secondary screen to simultaneously display flight phase information of a plurality of UAVs. This facilitates monitoring of UAVs based on identifier states and flight phases of the UAVs and helps determine which UAV requires focused observation or control in combination with the identifier states and flight phases of the UAVs. In addition, the use of multi-screen management for UAV fleets allows the main screen to synchronously display detailed information of the selected UAV based on operations performed on the secondary screen. This enables the target object to control the UAV on the main screen based on detailed information about the UAV.

Based on the same inventive concept, an embodiment of this disclosure further provides a flight device information display apparatus as described in the following embodiment. Because a principle of resolving a problem in the embodiment of the apparatus is similar to the above method embodiment, please refer to the implementation of the above method embodiment for the implementation of the embodiment of the apparatus. Repeated content is not described herein again.

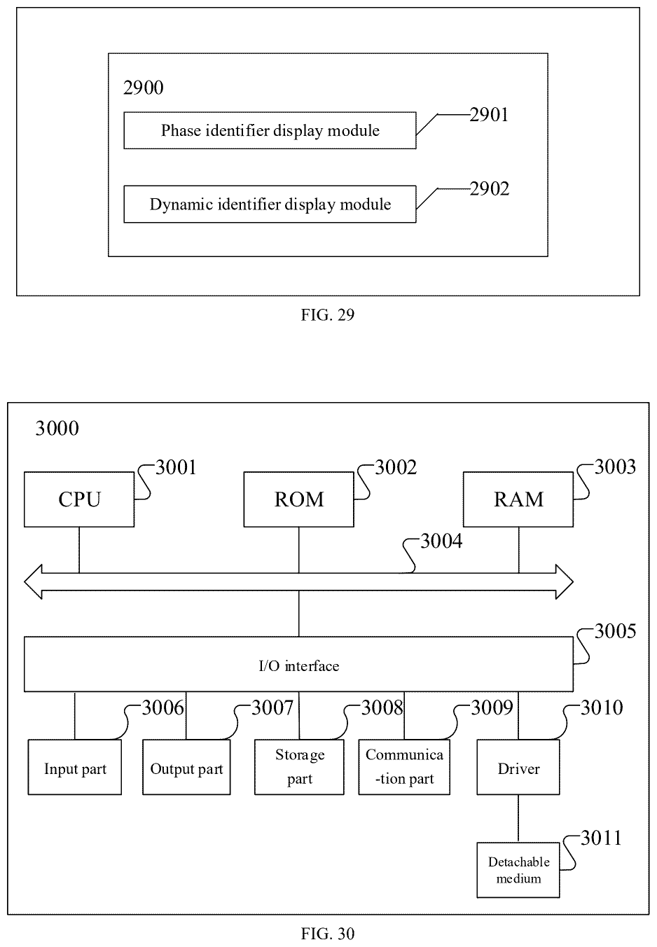

FIG. 29 is a block diagram of a flight device information display apparatus according to an exemplary embodiment. Refer to FIG. 29. The flight device information display apparatus 2900 provided in the embodiment of disclosure may include: a phase identifier display module 2901 and a dynamic identifier display module 2902.

The phase identifier display module 2901 can be configured to sequentially arrange phase identifiers of a plurality of flight phases of a flight device within a preset geographic range in a first information display region, and each flight phase is corresponding to one or more flight routes. The dynamic identifier display module 2902 can be configured to display, in response to a monitoring instruction, a dynamic identifier of the flight device at an associated location of a flight phase and a flight route in which the flight device is located.

In some embodiments, there are a plurality of preset geographic ranges, and phase identifiers corresponding to the plurality of preset geographic ranges are arranged horizontally or vertically in the first information display region. The phase identifiers of the plurality of flight phases are arranged horizontally or vertically in the first information display region. A plurality of flight routes within the same flight phase are arranged vertically.

In some embodiments, the flight device information display apparatus 2900 may further include: a static identifier display module.

In some embodiments, the preset geographic range includes a target geographic range.

The static identifier display module can be configured to display a static identifier of the flight device within the target geographic range in a preset region of the first information display region in response to the monitoring instruction.

In some embodiments, the dynamic identifier and/or the static identifier are also used to characterize a monitoring state of the flight device. The monitoring state includes a normal state, a selected state, and one or more abnormal states. The selected state is used to characterize that the dynamic identifier and/or the static identifier have been selected, and the abnormal state is used to characterize that the flight device is abnormal.

In some embodiments, there are a plurality of flight devices, including a target flight device, and the flight device information display apparatus 2900 may further include: a flight state information display module.

The flight state information display module can be configured to display, in response to a selection operation on the dynamic identifier or static identifier of the target flight device, state information and/or a control state switching control element of the target flight device in the first information display region, where the state information includes one or more of a device model, a task type, a flight state, takeoff time, an origin airport, and a control state.

In some embodiments, the flight device information display apparatus 2900 may further include: a control state switching module.

The control state switching module can be configured to switch a control state of the target flight device in response to a trigger operation on the control state switching control element.

In some embodiments, the flight device information display apparatus 2900 may further include a second information display region display module.

The second information display region display module can be configured to display one or more of a global panel, a monitor panel, a system information panel, a flight device state panel, and a remote control component in separate parts in a second information display region in response to the monitoring instruction, where the global panel is configured to display a two-dimensional map of a selected geographic range, the monitor panel is configured to display video feed data from a selected flight device, the system information panel is configured to display notification information of the flight device, the flight device state panel is configured to display a state parameter of the flight device, and the remote control component is configured to take over control of the selected flight device.

In some embodiments, the flight device information display apparatus 2900 may further include a video feed information display module.

The video feed information display module can be configured to display video feed data from the target flight device on the monitor panel and display a dynamic flight trajectory of the flight device within a selected geographic range on the two-dimensional map in response to a selection operation on the dynamic identifier or the static identifier of the target flight device.

In some embodiments, switching the control state of the target flight device includes switching the control state of the target flight device to a takeover state. In response to a trigger operation on the control state switching control element, the method further includes: activating a remote control component to control the target flight device.

Functions of the apparatus 2900 have been described in detail in a corresponding method embodiment, which are not described again in this disclosure.

FIG. 30 is a schematic structural diagram of an electronic device suitable for implementing the embodiments of this disclosure. It should be noted that the electronic device 3000 shown in FIG. 30 is merely an example and should not impose any limitation on functions and a scope of use of the embodiment of this disclosure. As shown in FIG. 30, the electronic device 3000 includes a central processing unit (CPU) 3001, which can perform various appropriate actions and processes based on programs stored in a read-only memory (ROM) 3002 or programs loaded into a random-access memory (RAM) 3003 from a storage part 3008. Various programs and data required for the operation of the electronic device 3000 are also stored in the RAM 3003. The CPU 3001, ROM 3002, and RAM 3003 are interconnected via a bus 3004. An input/output (I/O) interface 3005 is also connected to the bus 3004. The following components are connected to the I/O interface 3005: an input part 3006 including a keyboard, mouse, and the like; an output part 3007 including devices such as a cathode ray tube (CRT), a liquid crystal display (LCD), a speaker, and the like; a storage part 3008 including a hard disk; and a communication part 3009 including network interface cards such as an LAN card, a modem, and the like. The communication part 3009 performs communication processing via a network such as the Internet. A driver 3010 is also connected to the I/O interface 3005 as needed. A removable medium 3011, such as a magnetic disk, an optical disk, a magneto-optical disk, a semiconductor memory, and the like, is installed on the driver 3010 as needed, so that computer programs read from the driver can be installed into the storage part 3008 as needed. Specifically, according to an embodiment of this disclosure, the process described above with reference to the flowchart can be implemented as a computer software program. For example, an embodiment of this disclosure includes a computer program product that includes a computer program carried on a computer-readable storage medium, and the computer program includes computer program instructions for executing the method shown in the flowchart. In such an embodiment, the computer program can be downloaded and installed from the network via the communication part 3009 and/or installed from the removable medium 3011. When the computer program is executed by the CPU 3001, the above functions defined in the system of this disclosure are performed.

In another aspect, this disclosure further provides a computer-readable storage medium, which can be included in the device described in the above embodiment or exist separately without being assembled into the device. The computer-readable storage medium carries one or more programs. When the one or more programs are executed by one of the devices, the device can perform the following functions: sequentially arranging phase identifiers of a plurality of flight phases of a flight device within a preset geographic range in a first information display region, where each flight phase is corresponding to one or more flight routes; and displaying, in response to a monitoring instruction, a dynamic identifier of the flight device at an associated location of a flight phase and a flight route in which the flight device is located.

In related technologies, to manage the flight device, a motion trajectory of the flight device is usually displayed on a two-dimensional map. A target object can manage the flight device through the motion trajectory of the flight device displayed on the map. However, flight device information displayed in the above solution is complex and disorganized, making the target object capable of observing and managing only a limited quantity of flight devices. Therefore, a technical problem to be solved in this disclosure is how to display the flight device information, so that the target object can simultaneously manage a larger quantity of flight devices. In the flight device information display method and electronic device provided in this disclosure, the geographic range, the flight route, and flight phase of the flight device can be determined based on the location of the dynamic identifier of the flight device, effectively and concisely highlighting important reference data for controlling the flight device, enabling the target to promptly know a geographic range, a flight phase, and flight route of each flight device, to facilitate management and control of the flight device.

It should be understood that this disclosure is not limited to the detailed structures, the manner of illustration in the accompanying drawings, or implementation methods shown herein. On the contrary, this disclosure is intended to cover various modifications and equivalent arrangements within the spirit and scope of the appended claims.

1. A flight device information display method, comprising:
sequentially arranging phase identifiers of a plurality of flight phases of a flight device within a preset geographic range in a first information display region, wherein each flight phase is corresponding to one or more flight routes; and
displaying, in response to a monitoring instruction, a dynamic identifier of the flight device at an associated location of a flight phase and flight route in which the flight device is located.

2. The method according to claim 1, wherein there are a plurality of preset geographic ranges, and phase identifiers corresponding to the plurality of preset geographic ranges are arranged horizontally or vertically in the first information display region, the phase identifiers of the plurality of flight phases are arranged horizontally or vertically in the first information display region, and a plurality of flight routes within the same flight phase are arranged vertically.

3. The method according to claim 2, wherein the preset geographic range comprises a target geographic range, and after in response to the monitoring instruction, the method further comprises: displaying a static identifier of the flight device within the target geographic range in a preset region of the first information display region.

4. The method according to claim 3, wherein at least one of the dynamic identifier or the static identifier is also used to characterize a monitoring state of the flight device, the monitoring state comprises a normal state, a selected state, and one or more abnormal states, wherein the selected state is used to characterize that at least one of the dynamic identifier or the static identifier has been selected, and the abnormal state is used to characterize that the flight device is abnormal.

5. The method according to claim 3, wherein there are a plurality of flight devices, the flight devices comprise a target flight device, and the method comprises:
displaying, in response to a selection operation on the dynamic identifier or the static identifier of the target flight device, at least one of state information or a control state switching control element of the target flight device in the first information display region, wherein the state information comprises one or more of a device model, a task type, a flight state, takeoff time, an origin airport, and a control state.

6. The method according to claim 5, comprising: switching the control state of the target flight device in response to a trigger operation on the control state switching control element.

7. The method according to claim 6, wherein in response to the monitoring instruction, the method further comprises: displaying one or more of a global panel, a monitor panel, a system information panel, a flight device state panel, and a remote control component in separate parts in a second information display region, wherein the global panel is configured to display a two-dimensional map of a selected geographic range, the monitor panel is configured to display video feed data from a selected flight device, the system information panel is configured to display notification information of the flight device, the flight device state panel is configured to display a state parameter of the flight device, and the remote control component is configured to take over control of the selected flight device.

8. The method according to claim 7, wherein in response to the selection operation on the dynamic identifier or static identifier of the target flight device, the method further comprises: displaying video feed data from the target flight device on the monitor panel, and displaying a dynamic flight trajectory of the flight device within a selected geographic range on the two-dimensional map.

9. The method according to claim 7, wherein the switching the control state of the target flight device comprises switching the control state of the target flight device to a takeover state, and in response to a trigger operation on the control state switching control element, the method further comprises: activating the remote control component to control the target flight device.

10. An electronic device, comprising: a memory and a processor, wherein the memory is configured to store computer program instructions; and the processor invokes the computer program instructions stored in the memory to:
sequentially arrang phase identifiers of a plurality of flight phases of a flight device within a preset geographic range in a first information display region, wherein each flight phase is corresponding to one or more flight routes; and
display, in response to a monitoring instruction, a dynamic identifier of the flight device at an associated location of a flight phase and flight route in which the flight device is located.

11. The electronic device according to claim 10, wherein there are a plurality of preset geographic ranges, and phase identifiers corresponding to the plurality of preset geographic ranges are arranged horizontally or vertically in the first information display region, the phase identifiers of the plurality of flight phases are arranged horizontally or vertically in the first information display region, and a plurality of flight routes within the same flight phase are arranged vertically.

12. The electronic device according to claim 11, wherein the preset geographic range comprises a target geographic range, and after in response to the monitoring instruction, the processor is further configured: display a static identifier of the flight device within the target geographic range in a preset region of the first information display region.

13. The electronic device according to claim 12, wherein at least one of the dynamic identifier or the static identifier is also used to characterize a monitoring state of the flight device, the monitoring state comprises a normal state, a selected state, and one or more abnormal states, wherein the selected state is used to characterize that at least one of the dynamic identifier or the static identifier has been selected, and the abnormal state is used to characterize that the flight device is abnormal.

14. The electronic device according to claim 12, wherein there are a plurality of flight devices, the flight devices comprise a target flight device, and the processor is further configured to:
display, in response to a selection operation on the dynamic identifier or the static identifier of the target flight device, at least one of state information or a control state switching control element of the target flight device in the first information display region, wherein the state information comprises one or more of a device model, a task type, a flight state, takeoff time, an origin airport, and a control state.

15. The electronic device according to claim 14, wherein the processor is further configured to: switch the control state of the target flight device in response to a trigger operation on the control state switching control element.

16. The electronic device according to claim 15, wherein in response to the monitoring instruction, the processor is further configured to: display one or more of a global panel, a monitor panel, a system information panel, a flight device state panel, and a remote control component in separate parts in a second information display region, wherein the global panel is configured to display a two-dimensional map of a selected geographic range, the monitor panel is configured to display video feed data from a selected flight device, the system information panel is configured to display notification information of the flight device, the flight device state panel is configured to display a state parameter of the flight device, and the remote control component is configured to take over control of the selected flight device.

17. The electronic device according to claim 16, wherein in response to the selection operation on the dynamic identifier or static identifier of the target flight device, the processor is further configured to: display video feed data from the target flight device on the monitor panel, and display a dynamic flight trajectory of the flight device within a selected geographic range on the two-dimensional map.

18. The electronic device according to claim 16, wherein the switching the control state of the target flight device comprises switching the control state of the target flight device to a takeover state, and in response to a trigger operation on the control state switching control element, the method further comprises: activating the remote control component to control the target flight device.

19. A non-transitory computer-readable storage medium, on which computer program instructions are stored, wherein when the computer program instructions are executed by a processor, the process is caused to:
sequentially arrange phase identifiers of a plurality of flight phases of a flight device within a preset geographic range in a first information display region, wherein each flight phase is corresponding to one or more flight routes; and
display, in response to a monitoring instruction, a dynamic identifier of the flight device at an associated location of a flight phase and flight route in which the flight device is located.
